(19) United States
(12) Patent Application Publication
(10) Pub. No.: US 2003/0009771 A1
(43) Pub. Date: Jan. 9, 2003

(54) Method and system to provide a home style user interface to an interactive television system

(76) Inventor: Glen C. Chang, Kent, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/893,353

(22) Filed: Jun. 26, 2001

(51) Int. Cl. H04N 7/173; H04N 7/16

(52) U.S. Cl. 725/135; 725/112; 725/136

(57) ABSTRACT

A method of executing an event in an interactive television system, includes: associating a function with a location in an environment of the interactive television system; and in response to a selection of the function, enabling an event associated with the function. An apparatus for enabling a user interface in an interactive television system, includes: a set top box communicatively coupled to the display device and capable to transmit television signals to a display device, the set top box including a user interface engine capable to display a function associated with a location in an environment of the interactive television system; the set top box further including a controller capable to execute the user interface engine and to enable an event in response to a selection of the function.

### TECHNICAL FIELD

This disclosure relates generally to interactive television systems that provide interactive services, and more particularly but not exclusively, to a user interface for an interactive television system.

### BACKGROUND

An interactive television differs from a conventional television in that an interactive television includes additional information and communication technology capabilities. These additional capabilities open up the possibilities for offering services or functionalities that are traditionally unavailable by use of conventional televisions. To some extent, interactive televisions perform some functionality traditionally performed on a personal computer, such as web browsing, and e-mail service.

However, the trend of providing an interactive television that provides services traditionally found on a personal computer is accompanied with the challenge to provide an interactive television user interface that is easy to learn and operate. This challenge involves designing a user interface that can be easily learned and operated by users who are not familiar with personal computers, since some or many interactive television users do not have personal computer experience.

Accordingly, there is a need for an interactive television user interface that is easily learned and operated by all types of users.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an example of an interactive television (iTV) system that can implement an embodiment of the invention.

FIG. 2 is a block diagram illustrating the functionalities of the home-style user interface for the iTV system of FIG. 1.

FIG. 3 is a block diagram illustrating an example of an operation of the home-style user interface for the iTV system of FIG. 1.

FIG. 4 is a block diagram illustrating another example of an operation of the home-style user interface for the iTV system of FIG. 1.

FIG. 5 is a block diagram illustrating another example of an operation of the home-style user interface for the iTV system of FIG. 1.

FIG. 6 is a block diagram illustrating another example of an operation of the home-style user interface for the iTV system of FIG. 1.

FIG. 7 is a block diagram illustrating another example of an operation of the home-style user interface for the iTV system of FIG. 1.

FIG. 8 is a block diagram illustrating another example of an operation of the home-style user interface for the iTV system of FIG. 1.

FIG. 9 is a block diagram illustrating another example of an operation of the home-style user interface for the iTV system of FIG. 1.

FIG. 10 is a block diagram illustrating another example of an operation of the home-style user interface for the iTV system of FIG. 1.

FIG. 11 is a block diagram illustrating another example of an operation of the home-style user interface for the iTV system of FIG. 1.

FIG. 12 is a block diagram illustrating another example of an operation of the home-style user interface for the iTV system of FIG. 1.

FIG. 13 is a block diagram illustrating another example of an operation of the home-style user interface for the iTV system of FIG. 1.

FIG. 14 is a block diagram illustrating another example of an operation of the home-style user interface for the iTV system of FIG. 1.

FIG. 15 is a block diagram illustrating another example of an operation of the home-style user interface for the iTV system of FIG. 1.

FIG. 16 is a block diagram illustrating another example of an operation of the home-style user interface for the iTV system of FIG. 1.

FIG. 17 is a block diagram illustrating another example of an operation of the home-style user interface for the iTV system of FIG. 1.

FIG. 18 is a block diagram illustrating another example of an operation of the home-style user interface for the iTV system of FIG. 1.

FIG. 19 is a block diagram illustrating another example of an operation of the home-style user interface for the iTV system of FIG. 1.

FIG. 20 is a block diagram illustrating another example of an operation of the home-style user interface for the iTV system of FIG. 1.

FIG. 21 is a flowchart illustrating the setup of options associated with a location, according to an embodiment of the home-style user interface for the iTV system of FIG. 1.

FIG. 22 is a flowchart illustrating the invocation of an option associated with a location, according to an embodiment of the home-style user interface for the iTV system of FIG. 1.

FIG. 23 is a block diagram illustrating another example of an operation of the home-style user interface for the iTV system of FIG. 1.

FIG. 24 is a block diagram illustrating another example of an operation of the home-style user interface for the iTV system of FIG. 1.

FIG. 25 is a block diagram illustrating another example of an operation of the home-style user interface for the iTV system of FIG. 1.

FIG. 26 is a block diagram illustrating another example of an operation of the home-style user interface for the iTV system of FIG. 1.

FIG. 27 is a block diagram illustrating another example of an operation of the home-style user interface for the iTV system of FIG. 1.

FIG. 28 is a block diagram illustrating another example of an operation of the home-style user interface for the iTV system of FIG. 1.

### DETAILED DESCRIPTION OF THE ILLUSTRATED EMBODIMENTS

Embodiments of systems, methods, and devices for providing a home-style user interface for an interactive television system are described herein. As an overview, an embodiment of the invention provides a user interface that is designed to be similar to everyday surroundings. The user interface is designed based upon associations of activities with specific locations.

The term “home-style” is used to describe the user interface because in one embodiment of the user interface, different locations are associated with different activities (features) related to the location. For instance, different rooms in a building have different features associated with them. Or, different rooms in a dwelling, such as a house, have different features associated with them. In an embodiment, the user interface employs pictures, icons, words, animation, video, and/or other types of graphical and/or textual representations to depict places (e.g., rooms, cubicles, offices, or outdoor areas) in an environment (or area) surrounding (or near) the user of an interactive television system.

For example, the surrounding locations for a particular user of the user interface might be rooms in a household such as a kitchen. In that case, the word “Kitchen” might be associated with features such as a recipe database; information on television (TV) shows about cooking; a food inventory and/or electronic grocery list; and/or information associated with ordering food, restaurants, shopping, and/or the like. Further, the recipe database might be connected to other kitchen features, so that by accessing a recipe, the food inventory might be accessed and the electronic grocery list might be updated to reflect ingredients to purchase in advance of preparing the recipe. Additionally, there might be a cooking show on television or video that can be accessed where the show or video teaches the recipe. By associating features related to a particular location (in this example, the kitchen), the home-style user interface has the advantage of simplifying the electronic organization of information to a novice computer user. That is, by associating features with locations in real life where such features are available, the home-style user interface has the advantage of being simple to understand and operate, especially with regards to accessing computerized features.

Further, since a place such as a kitchen in a house is typically an environment that is shared by more than one interactive television system user (or in this example, a household member), in one embodiment the home-style user interface suitably provides no access restrictions to the features associated with the kitchen or to the features associated with other non-restricted locations in a house. In this manner, if a particular location has restricted access, then the home-style user interface may provide restricted access to the function associated with the restricted particular location, and/or to the features associated with the function. In this example, since a household kitchen environment typically has no access restriction in real life, the home-style user interface may accordingly provide unrestricted access to multiple users to the Kitchen function and/or to the features associated with the kitchen function.

In an actual house area, the master bedroom or a home office room might have features that need to be secured, such as a locked cabinet. In one embodiment, the home-style interface provides the capability to, for example, restrict (or password-protect) access to designated functions themselves. That is, the restricted location (function) will not allow access to the associated features in the restricted-access location without appropriate verification input. In one embodiment, the home-style interface provides the capability to, for example, password-protected the individual features associated with restricted functions (locations in a house) such as a master bedroom. Such password-protected features might include parental control of a television, an automatic climate control system, or a home-security system, as well as any number of -features, such as email, a calendar, a telephone directory, and/or the like. By associating normally secured features with a personalized location, such as a master bedroom, the home-style user interface can simplify the understanding of how the electronic information is organized and secured, and can provide a user interface that is easy to learn and use.

Accordingly, the invention advantageously provides a user interface for an interactive television system that overcomes the disadvantages of a more traditional personal computer user interface that is more likely to be used by one user at a time. The invention also advantageously permits its users to associate (or group) features offered via an interactive television system in a manner that is simple to understand because the features are associated with functions that represent everyday surrounding locations.

Embodiments of the present invention advantageously provide a user-friendly, home-style interface that is particularly well-suited to interactive television (iTV) services. Such iTV services are distinct and different from personal computer (PC) applications. The PC is generally a productivity platform. In contrast, iTV is more of an entertainment and commerce platform. Hence, while PC applications are typically “lean forward” in nature where the user directs the interaction to get work done, ITV services are typically more “lean back” in nature where the user is entertained or introduced to new products. The “lean back” nature of television fits well with the home-style orientation of the present invention.

In the description herein, numerous specific details are provided, such as examples of programming, user selections, transactions, and other features, to provide a thorough understanding of embodiments of the invention. One skilled in the relevant art will recognize, however, that the invention can be practiced without one or more of the specific details, or with other systems, methods, components, materials, and the like. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

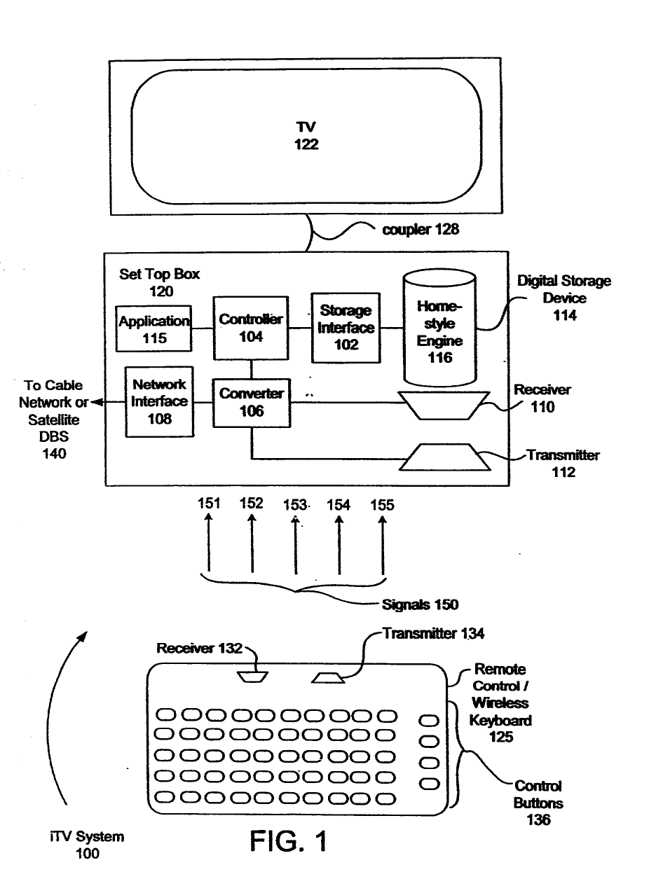

FIG. 1 is a block diagram of an interactive television (interactive TV or iTV) system 100 that can implement an embodiment of the invention. However, other types of systems may also be used to implement an embodiment of the invention. The iTV system 100 typically includes a set top box 120, television (display device) 122, and a remote control device (or wireless keyboard) 125. Set top box 120 may be a consumer electronics device that serves as a gateway between the television 122 and a broadband communication network, such as a cable network 140. The connection to the broadband communication network may continue to a data communication network, such as the Internet, by way of, for example, a public switched network (PSTN). The set top box 120 receives the programming content or television signals from the broadband communication network, and delivers the television signals to the television 122. The set top box 120 also enables a viewer to select a television program to view and then delivers the television program to the television 122.

Alternatively or in addition, Set top box 120 may be a consumer electronics device that serves as a gateway between the television 122 and a satellite TV delivery system, such as a direct broadcast satellite (DBS) system. A DBS system may comprise a small 18-inch satellite dish (which is the antenna fore receiving a satellite broadcast signal); a digital integrated receiver/decoder (IRD), which separates each channel, and decompresses and translates the digital signal so a television can show it. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center may be used to gather programming content, ensure its digital quality, and transmit the signal up to the satellites. Programming may come to the broadcast center from content and/or special digital tape. Satellite-delivered programming is typically immediately digitized, encrypted and uplinked to the orbiting satellites. The satellites retransmit the signal back down to every earth-station—or, in other words, every compatible DBS system receiver dish at customer's homes and businesses.

Some programs may be recorded on digital videotape in the broadcast center to be broadcast later. Before any recorded programs are viewed by customers, technicians may use post-production equipment to view and analyze each tape to ensure audio and video quality. Tapes may then be loaded into a robotic tape handling system, and playback may be triggered by a computerized signal sent from a broadcast automation system. Back-up videotape playback equipment may ensure uninterrupted transmission at all times.

Alternatively, or in addition, the television signals can be broadcast over a wireless medium and received by a traditional aerial antenna, and then delivered to the set top box 120.

As its name implies, a set top box is typically located on top of, or in close proximity to, a television. Alternatively or additionally, functionalities of a set top box may be integrated into a type of advanced television or other display device. For example, the functionalities of the set top box 120 can be built into circuitry of the television set 122 (e.g., an interactive television set). Another example is where there may be multiple set top boxes or where there is an “updated or expanded” set top box connected to the main set top box.

The set top box 120 includes a network interface 108 for interfacing with a broadband network such as the cable network 140. The set top box 120 may also include a converter 106 for converting digitally-encoded data streams (e.g., television signals) into a format directly readable by television 122. The set top box 120 receives the data streams from, for example, a broadband communication network, such as the cable network 140. As another example, the data stream is transmitted over a wireless medium and received by a traditional aerial antenna or by a satellite dish, and then delivered to the set top box 120. The digital encoding for the data streams may be, for example, in the Moving Pictures Experts Group (MPEG) format. The incoming data stream is processed by the set top box 120 and transmitted via coupler 128 for display on television 122. The coupler 128 may be, for example, a data transmission wire or a wireless path.

In the embodiment shown in FIG. 1, set top box 120 is further equipped with a receiver 110, such as an infrared (IR) or radio frequency (RF) receiver 110. In other embodiments, the receiver 110 may be configured to receive other frequencies of the electromagnetic spectrum, such as Ultrahigh Frequency (UHF), Very High Frequency (VHF), microwave, or the like. Receiver 110 receives control signals 150 from the remote control device 125 for operating the set top box 120 and the television 122, according to an embodiment of the invention. In one embodiment, the set top box 120 is further equipped with an optional transmitter 112, such as an IR or RF transmitter, for transmitting control signals to the remote control device 125.

In the embodiment shown in FIG. 1, set top box 120 further includes a controller (processor) 104 that is coupled with a storage interface 102 and the converter 106. The storage interface 102 provides an interface with a digital storage device 114, such as a hard disk drive or other memory device. In this illustrated embodiment, digital storage device 114 stores the software (e.g., home-style engine or user interface engine 116) that implements the home-style user interface and related data, as described below. However, the home-style engine (i.e., user interface engine) 116 may also be stored in another storage device that can be accessed by controller 104. Home-style engine 116 may be, for example, a program, module, instructions, or the like.

Controller 104 typically manages the operation of the set top box 120, including, for example, the execution of the home-style engine (user interface engine) 116 to permit users to setup and access functions (e.g., function 415) associated with the different surrounding locations, and to setup and access features (e.g. feature 505) associated with the different functions. In this embodiment, the locations are rooms in a household, as well as outdoor areas of a household such as a garden; however, the location may also be in other areas or environment. Controller 104 may be embodied as, for example, a micro-controller, microprocessor, digital signal processor (DSP), Application Specific Integrated Circuit (ASIC), field programmable gate array (FPGA), or other suitable devices.

In response to commands from the remote control device 125, home-style engine 116 can provide unrestricted access to functions associated with common-access locations (e.g., a room such as the kitchen), while restricting access to functions associated with personalized locations (e.g., a restricted-access room such as the master bedroom) according to an embodiment of the invention.

In response to commands from the remote control device 125, home-style engine 116 can further provide unrestricted access to features associated with a common-access function, while restricting access to features associated with personalized functions according to an embodiment of the invention.

In the embodiment shown in FIG. 1, set top box 120 further includes one or more applications 115 associated with the enabling/triggering of various events. For example, the applications 115 may include a browser for accessing a Uniform Resource Locator (URL) address on the Internet and for permitting web pages in a URL address to be displayed on the television 122. Alternatively or in addition, the applications 115 may also include an e-mail application for permitting e-mail messages to be transmitted from and received by the set top box 120. Thus, the applications 115 may represent one or more application. The applications 115 may be stored in the digital storage device 114.

Remote control device 125 provides convenient remote control operation of the set top box 120 and/or the television 122. In one embodiment, remote control device 125 suitably includes a keyboard and/or control buttons 136. In the embodiment shown in FIG. 1, remote control device 125 may include a receiver 132, such as an RF or IR receiver, for receiving control signals transmitted by the optional transmitter 112 of the set top box 120. Remote control device 125 further includes a transmitter 134, such as an RF or IR transmitter, for transmitting control signals (commands) and other data to the receiver 110 of the set top box 120. The remote control device 125 can also transmit control signals to the television 122 in order to enable certain operations, such as the adjustment of the television volume and the like.

In one embodiment, the transmitters 112 and 134 modulate control signals with a carrier frequency to enable transmission of information between set top box 120 and remote control device 125. For example, transmitters 112 and 134 may operate according to Institute of Electrical and Electronics Engineers (IEEE) 802.11a or 802.11b Wireless Networking Standards. Alternatively, transmitters 114 and 134 may rely on the Digital Enhanced Cordless Telecommunications (DECT) technology, the “Bluetooth” protocol, or other suitable standard or proprietary protocols. To achieve signal modulation and transmission, transmitters 112 and 134 may include various additional components not specifically illustrated. For example, transmitters 112 and 134 may include source encoders to reduce the amount of bandwidth required, channel encoders to modulate the transmitted information with a carrier wave, and transmission antennas to permit signal broadcast. An antenna for the transmitter 112 may be, for example, a substantially two-dimensional structure formed as part of a printed circuit board within the set top box 120. Similarly, an antenna for the transmitter 134 may be, for example, a substantially two-dimensional structure formed as part of a printed circuit board within remote control device 125. Such integrated antennas are advantageously compact and efficient to manufacture. Transmitters 112 and 134 may further include amplifiers to increase the transmission signal strength to an appropriate power level.

To permit control signal reception and de-modulation, receivers 110 and 132 may include various additional components not specifically illustrated. For example, receivers 110 and 132 may include antennas for receiving the transmitted control signal, amplifiers for increasing the strength of the received control signal, and decoders for separating and demodulating the received information from the carrier signal. The antenna of the receiver 110 may be formed as part of a printed circuit board within the set top box 120, while the antenna of the receiver 132 may be formed as part of a printed circuit board within the remote control device 125.

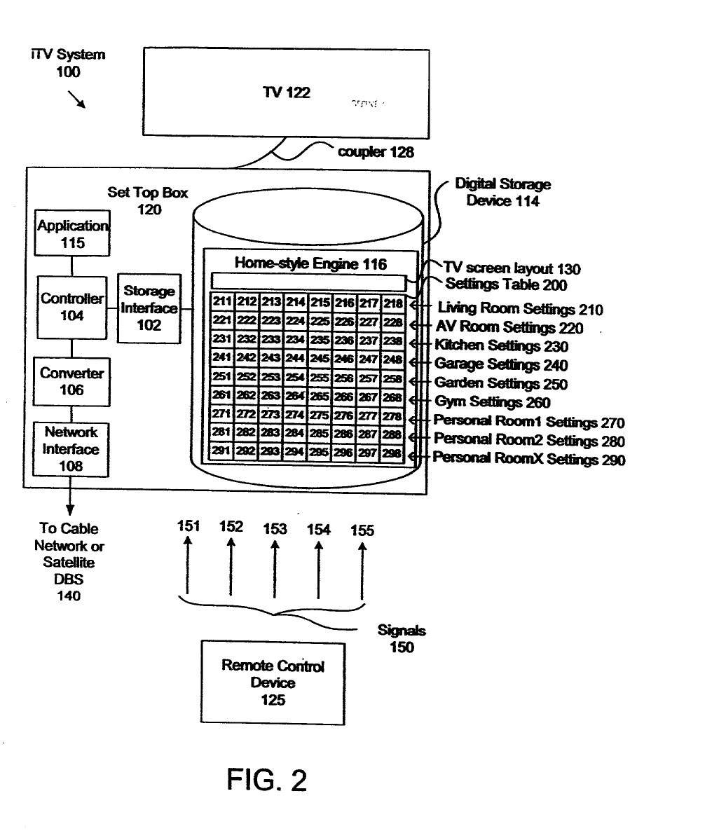

Reference is now made to the block diagram of FIG. 2 in order to describe the operation of the home-style user interface as performed by an embodiment of the invention. The remote control device 125 transmits one or more control signals 150 in response to user input. For control signals 150 received by set top box 120 and related to the operation of the iTV system 100, the controller 104 executes the home-style system engine (user interface engine) 116 and/or applications 115 to interpret and process the received information.

The following control signals may enable the following home-style system operations as shown in Table 1. It is noted that at least one command in Table 1 may be omitted and that other types of commands may be included in or substituted in Table 1.

TABLE 1

| Command | Home-Style System Operation |
|---|---|
| Signal 151 | Display Top-Level iTV Interface |
| Signal 152 | Up Arrow |
| Signal 153 | Down Arrow |
| Signal 154 | Enter |
| Signals | Alphanumeric keys (i.e. Signal 155x |
| 155 | represents the “x” key) |

In one embodiment, home-style engine 116 suitably provides a settings table 200 (or a series of “setting” fields, also known as status indicators) that stores information associated with each one of the features associated with a particular function (location). In the embodiment illustrated in the following figures, the functions (locations) may be within (or in the vicinity of) a house. However, the particular function (and its associated location) is not limiting, and the particular function may correspond to another area such as, for example, a commercial office building or hotel. Each function has an associated setting or plurality of settings in an embodiment of the home-style user interface. For example, the house may have at least one of the following groups of settings, where each group of settings corresponds to a particular function: living room settings 210, audio-visual (AV) room settings 220, kitchen settings 230, garage settings 240, garden settings 250, gym settings 260, and/or one or more personal room settings (personal room 1 settings 270, personal room 2 settings, . . . through personal room X settings 290). Other types of settings may be included in or may be substituted in the plurality of settings in FIG. 2. Home-style engine 116 also provides a TV screen layout 130 for formatting information to be displayed on television 122.

Each -feature associated with a particular function (location) has an active/inactive setting (also referred to as a state or status indicator) for activating or deactivating the feature. Each feature may also have information about an associated triggerable event, such as an executable application 115 that can be selectively invoked via interactive TV system 100 when the state is active. The information about an executable event might be an address of (or pointer to) an executable application 115. When home-style engine 116 is directed by the user of iTV system 100 to access that particular active feature, the controller 104 uses the address or pointer information in order to trigger the associated event (i.e. execute an application 115 associated with the feature that the user wants to access).

The following settings equate to the following functions and features as shown in Table 2, which provides a convenient reference and further detail about which of the settings in settings table 200 (FIG. 2) belong to which features. It is noted that at least one of the functions and/or features shown in Table 2 may be omitted from settings table 200 and that other types of functions or features may be included in or substituted in settings table 200.

TABLE 2

| Settings | Feature |
|---|---|
| Setting 211 | Living Room Finance Feature |
| Setting 212 | Living Room News & Events Feature |
| Setting 213 | Living Room Family Calendar |
| | Feature |
| Setting 214 | Living Room Web Feature |
| Setting 215 | Living Room TV Feature |
| Setting 216 | Living Room Phone Feature |
| Setting 217 | Living Room Email Feature |
| Setting 218 | Living Room Other Feature |
| Setting 221 | AV Room Finance Feature |
| Setting 222 | AV Room News & Events Feature |
| Setting 223 | AV Room Family Calendar Feature |
| Setting 224 | AV Room Web Feature |
| Setting 225 | AV Room TV Feature |
| Setting 226 | AV Room Phone Feature |
| Setting 227 | AV Room Email Feature |
| Setting 228 | AV Room Other Feature |
| Setting 231 | Kitchen Recipes Feature |
| Setting 232 | Kitchen Cooking Shows Feature |
| Setting 233 | Kitchen Food Inventory Feature |
| Setting 234 | Kitchen Order Food Feature |
| Setting 235 | Kitchen Restaurants Feature |
| Setting 236 | Kitchen Shopping Feature |
| Setting 237 | Kitchen Appliances Feature |
| Setting 238 | Kitchen Other Feature |
| Setting 241 | Garage Tools Feature |
| Setting 242 | Garage Automobile Feature |
| Setting 243 | Garage Boat Feature |
| Setting 244 | Garage Sale Feature |
| Setting 245 | Garage Storage Inventory Feature |
| Setting 246 | Garage Carpool Scheduling Feature |
| Setting 247 | Garage Bus Schedule Feature |
| Setting 248 | Garage Other Feature |
| Setting 251 | Garden Sprinkler System Feature |
| Setting 252 | Garden Planting Schedule Feature |
| Setting 253 | Garden Botanical Information |
| | Feature |
| Setting 254 | Garden Tools Feature |
| Setting 255 | Garden Yard Maintenance Schedule |
| | Feature |
| Setting 256 | Garden Bird Watching Information |
| | Feature |
| Setting 257 | Garden Barbeque Feature |
| Setting 258 | Garden Swimming Pool Feature |
| Setting 261 | Gym Membership Feature |
| Setting 262 | Gym Equipment Feature |
| Setting 263 | Gym Workout Schedule Feature |
| Setting 264 | Gym Baseball Practice Schedule |
| | Feature |
| Setting 265 | Gym Other Feature |
| Setting 266 | Gym Other Feature |
| Setting 267 | Gym Other Feature |
| Setting 268 | Gym Other Feature |
| Setting 271 | Personal Room 1 School Feature |
| Setting 272 | Personal Room 1 Sports Feature |
| Setting 273 | Personal Room 1 Music Feature |
| Setting 274 | Personal Room 1 Web Feature |
| Setting 275 | Personal Room 1 TV Feature |
| Setting 276 | Personal Room 1 Phone Feature |
| Setting 277 | Personal Room 1 Email Feature |
| Setting 278 | Personal Room 1 Other Feature |
| Setting 281 | Personal Room 2 School Feature |
| Setting 282 | Personal Room 2 Sports Feature |
| Setting 283 | Personal Room 2 Music Feature |
| Setting 284 | Personal Room 2 Web Feature |
| Setting 285 | Personal Room 2 TV Feature |
| Setting 286 | Personal Room 2 Phone Feature |
| Setting 287 | Personal Room 2 Email Feature |
| Setting 288 | Personal Room 2 Other Feature |
| Setting 291 | Personal Room X School Feature |
| Setting 292 | Personal Room X Sports Feature |
| Setting 293 | Personal Room X Music Feature |
| Setting 294 | Personal Room X Web Feature |
| Setting 295 | Personal Room X TV Feature |
| Setting 296 | Personal Room X Phone Feature |
| Setting 297 | Personal Room X Email Feature |
| Setting 298 | Personal Room X Other Feature |

Some examples of the features listed in Table 2 are now described. For example, the “Finance” feature may typically be a portal to financial links on the World Wide Web, TV channels related to finance (e.g., CNNFN), and/or a financial software application that is typically loaded into the set top box 120. The financial software application has, for example, capabilities similar to that of the MS Money™ application or Quicken™ application adapted for the TV and set top box environment. Thus, selecting a feature enables the triggering of an event, such as an execution of at least one application, and/or presentation to the user of information related to the selected feature, and/or any other activity related to the selected feature. This definition of “event” should not be confused with the word “Events,” as employed in the phrase “News and Events,” which refers to a feature relating to “Current Events.”

As another example, the “News & Events” feature may typically be a portal that highlights the latest news and/or links to news websites (e.g., cnn.com), TV channels (e.g., CNN, FOX News Channel, and/or local news in various channels).

As another example, the “Family Calendar” feature typically enables the execution of a similar application that currently resides in a set top box. However, this feature may instead trigger a web-based application for remote access. Typically, the “Family Calendar” would behave similarly to the calendar feature of, for example, MS Outlook™. Alternatively or in addition, the “Family Calendar” feature may optionally include “hot-synching” the “Family Calendar” with a personal digital assistant (PDA) or with another type of suitable device. The “Family Calendar” may be personalized and available for each member of the household, since individuals typically have their own schedule.

The “Web” feature may typically be a web portal such as, for example, www.Yahoo.com or www.MSN.com.

The “TV” feature typically permits the viewing of live television shows or recorded TV shows.

The “Phone” feature may be a Voice-Over-IP phone feature (e.g., DialPad™), or a video-conferencing feature (e.g., NetMeeting™ or CUSeeMe™).

The “Email” feature typically enables Email messaging and could also include voice-mail and/or video-mail capabilities.

The “School” feature is typically an education-related portal. For example, the user may access an encyclopedia, dictionary, thesaurus, handbooks, and/or the like. If a school is wired and has the appropriate network capabilities, the “School” feature may, for example, enable the downloading of coursework and/or homework and/or enable the video-conferencing to a class if the student-user is, for example, sick and is unable to physically attend class, or if the student-user is “tele-schooling”.

The “Sports” feature is typically a sports portal with web site links and/or access to TV channels (e.g., ESPN, FOX Sports Channel, and ABC). This feature would, for example, reflect the user's preference for the certain types of sports and teams of choice. As another example, this feature might include information, research and website links to sports and sports-related shopping (e.g. information on sports instruction such as golf lessons and tips).

The “Music” feature is typically a music portal. This feature enables, for example, access to web sites for music listening, purchasing, and/or downloading. Alternatively or in addition, this feature may also enable E-commerce opportunities for electronic music purchases and ordering of music compact disks and more. Alternatively or in addition, there could be a music jukebox for managing the music collection of the user, or for listening and downloading to a portal music player such as, for example, an MP3 player such as the Rio™ MP3 player from SONICblue Incorporated (Diamond Multimedia Division). Alternatively or in addition, the “Music” feature may enable a wireless transmission such as, for example, the downloading of music to the car of the user.

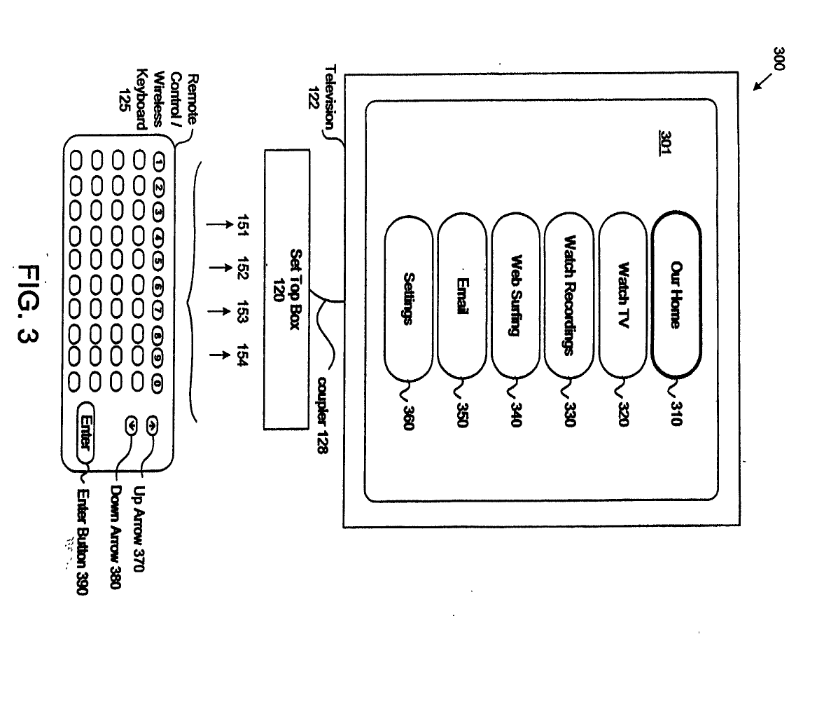

FIG. 3 is a block diagram illustrating an example 300 of an operation of the iTV system 100 of FIG. 1. Example 300 shows a top-level iTV interface menu 301, which is formatted and displayed by home-style engine 116, upon receiving and interpreting control signal 151 from remote control device 125. Home-style engine 116 formats the top-level iTV interface in TV screen layout 130 (FIG. 2) and transmits layout 130 to television 122 via coupler 128. In the example of FIG. 3, the top-level iTV interface menu 301 displays an “Our Home” option 310 along with the traditional iTV options, which for instance, allow a user to watch TV (option 320), watch video recordings (option 330), surf the web (option 340), check e-mail (option 350), or make changes to the iTV environment (option 360). It is noted that FIG. 3 shows an example of a graphical representation of the options 310, 320, 330, 340, 350, and 360. Thus, the options 310, 320, 330, 340, 350, and 360 may be shown in the menu 301 in other forms such as pictures, icons, text, animation, video and/or other graphical and/or textual representations or combinations of various types of representations. Furthermore, if the iTV system 100 is implemented in another environment, such as a hotel resort room, then the option 310 may have a different title such as, for example, “Hotel Features”.

Example 300 shows “our home” option 310 highlighted, as denoted by the heavier line weight surrounding the option name. In an embodiment, home-style engine 116 initializes the display of a menu, such as the top-level iTV interface menu 301, by highlighting one of the displayed options. The significance of an option being highlighted is that pressing the enter button 390 on remote control device 125 invokes the option that is highlighted. Thus, in this embodiment one option is highlighted at a time.

In example 300, the highlighted option is “our home” option 310. If that is the option that the user of iTV system 100 wants to invoke, then all the user typically needs to do is to press the Enter button 390 on remote control device 125. Remote control device 125 transmits control signal 154 to set top box 120. Controller 104 (FIG. 2) passes the information to home-style engine 116. Home-style engine 116 knows how to respond to the Enter command, because home-style engine 116 previously formatted and displayed one of the options as highlighted in example 300. Home-style engine 116 responds by formatting the home-style menu in TV screen layout 130 and transmitting layout 130 to television 122 via coupler 128.

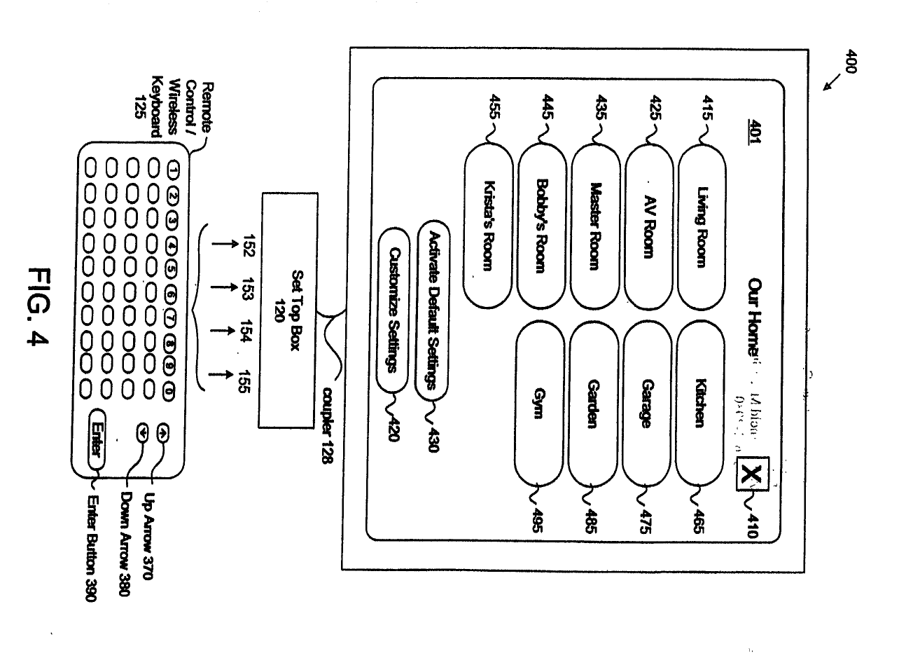

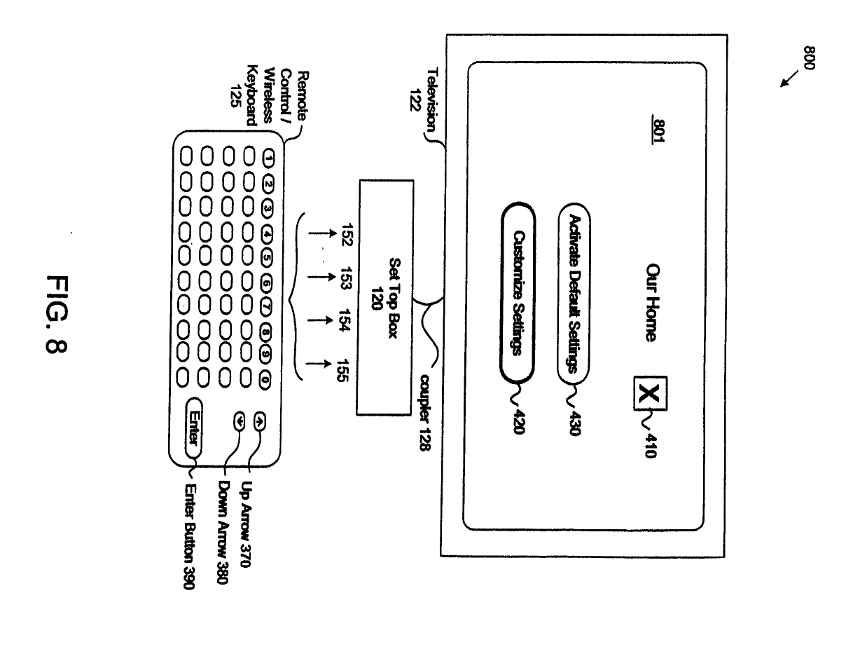

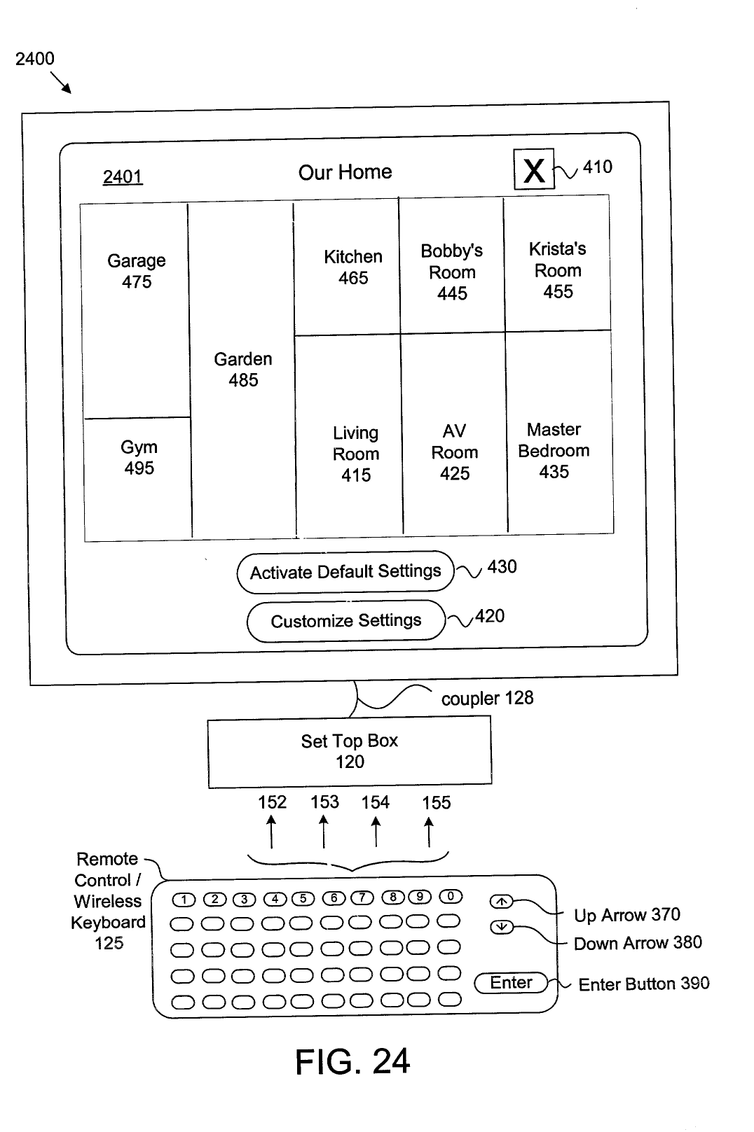

Referring now to FIG. 8, example 800 illustrates the home-style menu 801. Example 800 represents how the home-style menu appears before any of the room settings are active. Referring also now to FIG. 4, example 400 illustrates a second example of home-style menu 401 where at least one of the settings each of nine rooms is active. How the home-style menu appears depends upon which functions (rooms) have active settings. That is, the functions (rooms) that appear on the home-style menu represent functions that have at least one active setting. Example 800 reflects the case where none of the settings for any of the functions (rooms) are active. Example 400 represents the case where settings corresponding to nine functions (rooms) are active. It is noted that FIG. 4 shows one example of a graphical representation of the functions 415, 425, 435, 445, 455, 465, 475, 485, and 495. Referring also to FIG. 24, the functions 415, 425, 435, 445, 455, 465, 475, 485, 495 may also be shown in the menu 2401 in other forms, such as pictures, icons, text, animation, video and/or other graphical and/or textual representations or combinations of various types of representations.

Home-style engine 116 determines which functions (rooms) to display on the home-style menu as follows. When prompted to display the home-style menu, home-style engine 116 checks the status indicators in settings table 200 (Living Room settings 210, AV room settings 220, Kitchen settings 230, Garage settings 240, Garden settings 250, Gym settings 260, Personal Room 1 settings 270, Personal Room 2 settings, . . . and Personal Room X settings 290) to determine which, if any, of the features corresponding to each of those settings are active. For any function (room) with one or more active features, home-style engine 116 considers the function active and displays the function (room) on the home-style menu. In example 800, since none of the features for any of the functions are yet active, home-style engine 116 displays none of the functions (rooms).

Example 800 also shows an exit option 410. Exit option 410 appears on a number of the home-style screens and can be selected (e.g., highlighting the option 410 and pressing enter button 390). Upon the selection of the exit option 410, home-style engine 116 typically formats the next highest-level menu on TV screen layout 130, and transmits TV screen layout 130 to television 122 via coupler 128. Television 122 interprets TV screen layout 130 and displays the next highest-level menu. For example, from the home-style menu, the next highest-level menu is the top-level iTV interface menu 301 (FIG. 3). More generally the next highest-level menu is typically the menu that originally invoked the current menu.

In an embodiment, in order to make the home-style user interface as easy to use as possible, settings may be initialized prior to the first time that they are made available on a particular interactive TV system (a.k.a. software product initialization). For instance, the settings might be initialized so that certain settings corresponding to features that are predetermined to be the most popular features are active by default (e.g. referring again to FIGS. 4 and 24, settings corresponding to features corresponding to all nine functions (rooms) shown in menus 401 and 2401 might be active).

In another embodiment, the software product initialization may mean that settings are all initialized to an inactive state as shown in example 800. In this case, an option 430 that allows activation of “default” settings is provided to facilitate setup and use of the home-style user interface. Activate Default Settings (option 430) can be employed to activate a predetermined group of settings (for instance, those settings that correspond to features that are thought by marketers and product designers to be the most popular features).

Initialization to active of one or more predetermined settings makes the user interface easier to use. Additionally, initialization of on or more predetermined settings accommodates users who may not want to be bothered with customization of the home-style interface. Additionally, or alternatively, a default settings option also serves these purposes.

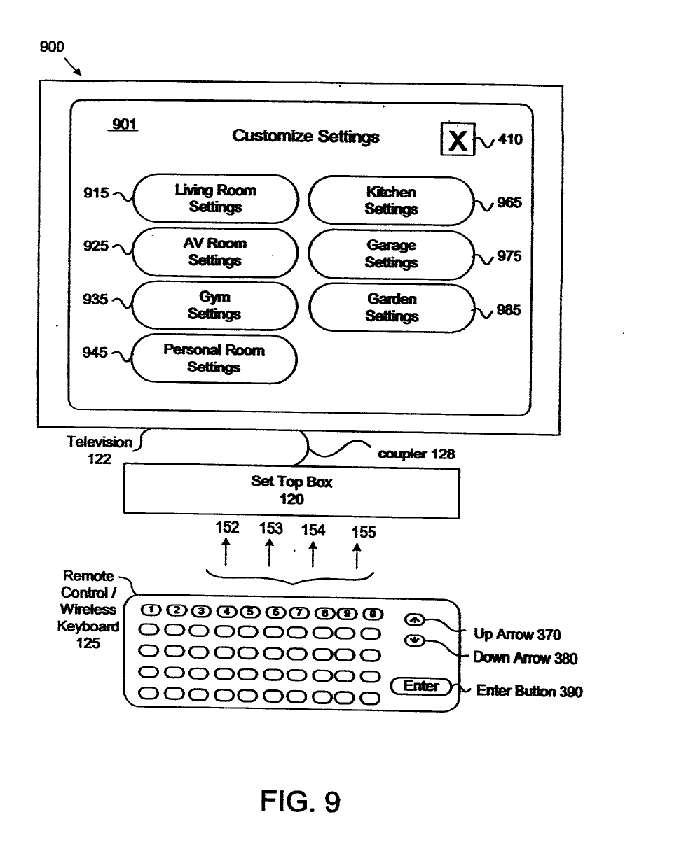

To describe the full customization capabilities of the home-style user interface, a series of examples is now presented in an embodiment where none of the settings are initialized to active. Still referring to example 800, to change the active/inactive state of any of the features, the user of remote control device 125 typically selects the Customize Settings option 420. Since example 800 shows the Customize Settings option 420 highlighted, the user of remote control device 125 typically needs only to press the Enter button 390 to invoke the option 420. Remote control device 125 processes the information entered and transmits control signal 154. Set top box 120 receives control signal 154 and relays the control signal to home-style engine 116. Home-style engine 116 interprets control signal 154 and formats the Customize Settings menu 901 (FIG. 9) on TV screen layout 130 for display on television 122 (FIG. 9).

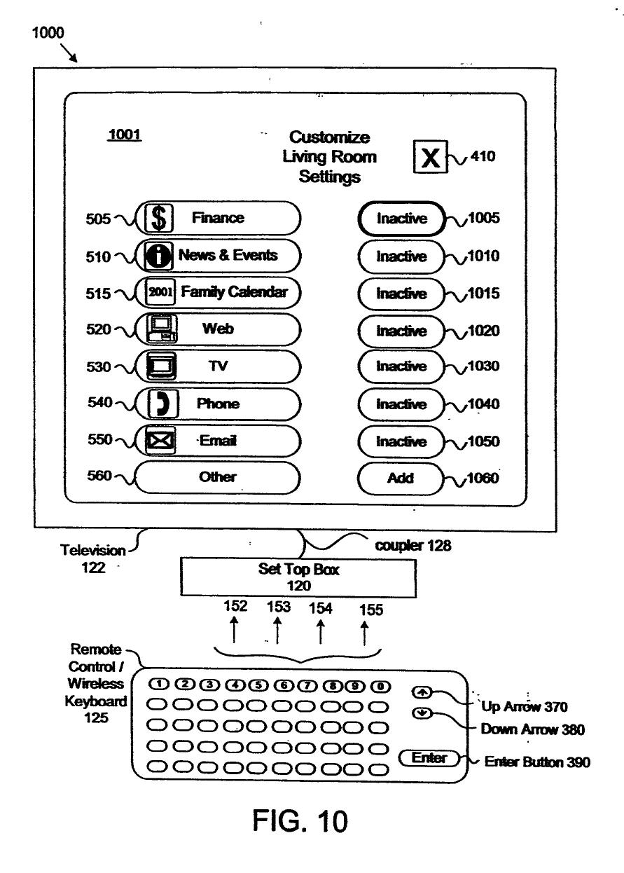

Referring now to FIG. 9, example 900 illustrates the home-style settings menu 901 that allows a user of the interactive TV system to customize settings for the different functions (rooms). In an embodiment, the home-style settings menu 901 includes, for example, the capability for customizing settings corresponding to features for a living room function (option 915), an audiovisual room function (option 925), a gym function (option 935), one or more personal room functions (option 945), a kitchen function (option 965), a garage function (option 975), and/or a garden function (option 985). To change the active/inactive state indicator for features corresponding to any of the functions (rooms), the user of remote control device 125 first selects the appropriate option corresponding to the function. For example, to change the active/inactive state for any of the living room features, the user of remote control device 125 first selects Living Room Settings option 915. Upon receiving an appropriate control signal and interpreting the request, home-style engine 116 formats a list of active and inactive living room features from the information in Living Room Settings 210 (FIG. 2, see also settings 211-218 in Table 2)) on TV screen layout 130, transmits TV screen layout 130 to television 122 via coupler 128 for television 122 to display the Customize Living Room Settings menu 1001 (FIG. 10).

Referring to FIG. 10, example 1000 illustrates the Customize Living Room Settings menu 1001 that shows the state of all available preset features as inactive. Each preset feature (non-customizable feature) has an associated active/inactive setting. For instance, the finance feature (505) has an associated active/inactive state (option 1005), which is currently inactive. In an embodiment, on this type of settings menu 1001 the user can highlight any of the active/inactive states (e.g. options 1005-1050), the other feature option 1060, and the exit option 410, by scrolling (i.e., pressing the up arrow 370 or the down arrow 380). However, the living room features themselves (505 through 560) typically cannot be highlighted or selected on this type of settings menu.

In an embodiment, home-style engine 116 provides “preset” features associated with a living room, including, for example, the following features: Finance (505), News and Events (510), Family Calendar (515), Web (520), TV (530), Phone (540), and Email (550). The state corresponding to each of the preset features toggles from active to inactive when the corresponding active/inactive option is selected. For instance, selecting the option 1005 associated with the preset finance feature 505 toggles both the setting 211 and the displayed state of the setting (option 1005) to Active. That is, if the setting is inactive in settings table 200 (FIG. 2), then selecting the corresponding inactive option changes the setting to active in settings table 200, as well as changing the displayed status indicator option to active. The converse of these parallel operations is also true. For instance, if the setting is active in settings table 200, then selecting the corresponding status indicator of active changes the state to inactive in settings table 200, as well as changing the displayed status indicator to inactive.

In an embodiment, “preset” features are those that have a triggerable event (i.e. an executable application 115 stored on set top box 120) already associated with them, and which appear by default on a particular function settings menu so that each of them can be activated very quickly by selecting the corresponding option on the settings menu. To activate any of the preset features, the user of remote control device 125 selects the corresponding option (e.g., by highlighting an inactive option displayed for the associated preset feature and pressing the enter button 390). Home-style engine 116 then flags as active the setting in settings table 200 that is associated with the present feature (FIG. 2, Table 2). Home-style engine 116 then redisplays option corresponding to the preset feature as active.

For example, finance feature 505 has an associated active/inactive living room finance feature setting 211 (Table 2) in settings table 200, as well as an associated option 1005 that is employed by the user of the home-style user interface to activate/deactivate setting 211. In this example, option 1005 is displayed as “inactive,” to reflect the state of setting 211 in settings table 200.

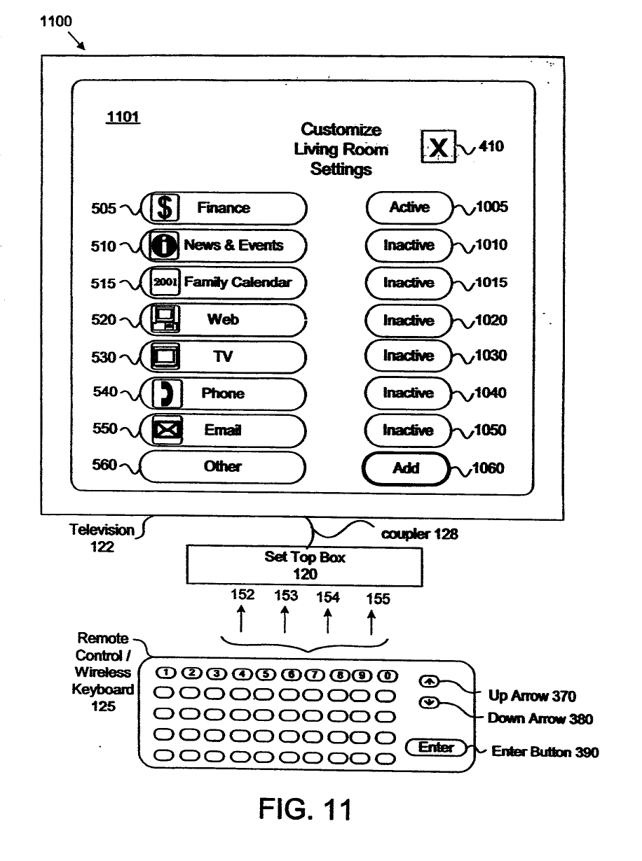

To change the state of setting 211 to active, the user of remote control device 125 employs the up arrow key 370 or down arrow key 380 to highlight option 1005 and presses the enter button 390. Remote control device 125 processes the information entered and transmits control signal 154 to the set top box 120. Set top box 120 receives control signal 154 and relays the control signal to home-style engine 116. Home-style engine 116 interprets control signal 154 and determines that the user intends to toggle option 1005, because home-style engine 116 keeps track of the particular field (shown on the display) previously formatted as highlighted. Home-style engine 116 also determines that option 1005 is currently displayed as inactive, and reformats the display of option 1005 to be “active.” Home-style engine also changes from inactive to active the setting 211 (in settings table 200) that corresponds to the option 1005. Home-style engine then displays the updated Customize Living Room Settings menu on television 122 with option 1005 displayed as active (see FIG. 11).

Each preset feature also has an associated icon, which serves to facilitate a user's learning of the home-style user interface product. The icons serve to visually associate an application in a manner similar to the function that icons serve in a personal computer user interface. That is, once a user begins to associate certain icons with certain features, the user no longer needs to read all the text. Instead, the user will more quickly recognize the feature by its icon.

For instance, the Finance feature 505 has an associated icon depicted herein by a dolloar sign; the News and Events feature has an associated icon depicted herein by a circle around the letter “i;” the Calendar feature has an associated icon depicted herein by the numbers “2001” (denoting calendar year); the Web feature has an associated icon depicted herein by a graphic of a personal computer; the TV feature has an associated icon depicted herein by a graphic of a television; the Phone feature has an associated icon depicted herein by a graphic of a telephone handset; and the E-mail feature has an associated icon depicted herein by a graphic of an envelope.

Icons may be more pictorial than are represented in these figures, and may suitably be provided by the event (i.e. application 115) associated with the feature. For instance, if the finance feature 505 were associated with the MS Excel™ application 115, then the icon would suitably be the standard MS Excel™ icon (an X in a box in front of a piece of paper).

In an embodiment, home-style engine 116 tracks information that reflects the active or inactive state of settings, as well as information about how to trigger a particular event for each feature. Information about each triggerable event might include information about how to invoke a particular application 115, and/or the type (or category) of application 115. For instance, each application 115 typically has a defined set of application programming interfaces (API's), and one of the jobs of the API's is to identify the application to the system as to what category or type of application it is (i.e. game, financial application, communication, media player, etc). Home-style engine 116 calls the API's and queries the application, which responds with a predetermined answer. By querying for type, home-style engine 116 knows how to invoke a particular application for each option. Home-style engine 116 suitably stores other types of information for other types of executable events.

When the user of home-style engine 116 effects a change of a setting from inactive to active, or vice versa, home-style engine 116 reflects the changed status. In this example, living room finance feature 505 is associated with home-style engine setting 211 in settings table 200 (see also Table 2). Setting 211 is updated to reflect the active state of the living room finance feature 505. Because finance feature 505 is a preset feature, home-style engine 116 associates a particular predetermined executable event (such as a particular application 115) with finance feature 505. Referring to FIG. 11, example 1100 illustrates the Customize Living Room Settings menu 1101 that shows the finance feature 505 as active, but the rest of the preset features 510 to 550 as inactive. In contrast, as stated above, the example of the Customize Living Room Settings menu 1001 in FIG. 10 shows the finance feature 505 as inactive.

In addition to the preset features 505 through 550, home-style engine 116 may provide a customizable “other” feature 560, which has an add option 1060 for assigning a feature to a particular function (room). Each function (room) settings menu typically has an “other” feature with a corresponding option that enables the addition of features other than the preset features preset for a particular function. Thus, Customize Living Room Settings menu 1101 has an “other” feature 560 with an associated add option 1060 for adding a feature to the living room function. The user of remote control device 125 may select the option 1060 associated with the “other” feature 560 to select a feature to add to the living room.

The “other” feature 560 allows the user of remote control device 125 to add a particular customized (i.e. not preset) feature for a particular function (room). In one embodiment, home-style engine 116 has a list of features that can be customized (i.e. added) to a function. In that case, home-style engine 116 may have a particular executable event (such as a particular application 115) associated with customizable features, because those features are already identified to home-style engine 116 and need only be associated with one or more particular functions by the user of the home-style user interface on the iTV system.

In another embodiment there may be additional customization capabilities, which include adding features that are not already identified to home-style engine 116. In this case, the user of the home-style interface must provide home-style engine 116 with sufficient information to allow an event to be triggered in association with the invocation of a customized feature.

In both cases, because there is no one particular triggerable event associated with the “other” feature, there is no icon that is displayed in association with the “other” feature. Once a customized feature has been sufficiently identified (as explained in the discussion that follows), an icon can be suitably provided in association with the customized feature.

Activation of a customizable feature requires additional information from the user of remote control device 125. In one embodiment, the “other” feature 560 permits the adding of a particular executable event (i.e. a particular application 115) that is already identified to home-style engine 116 and stored in the set top box 120 or in a memory device that is accessible by controller 104.

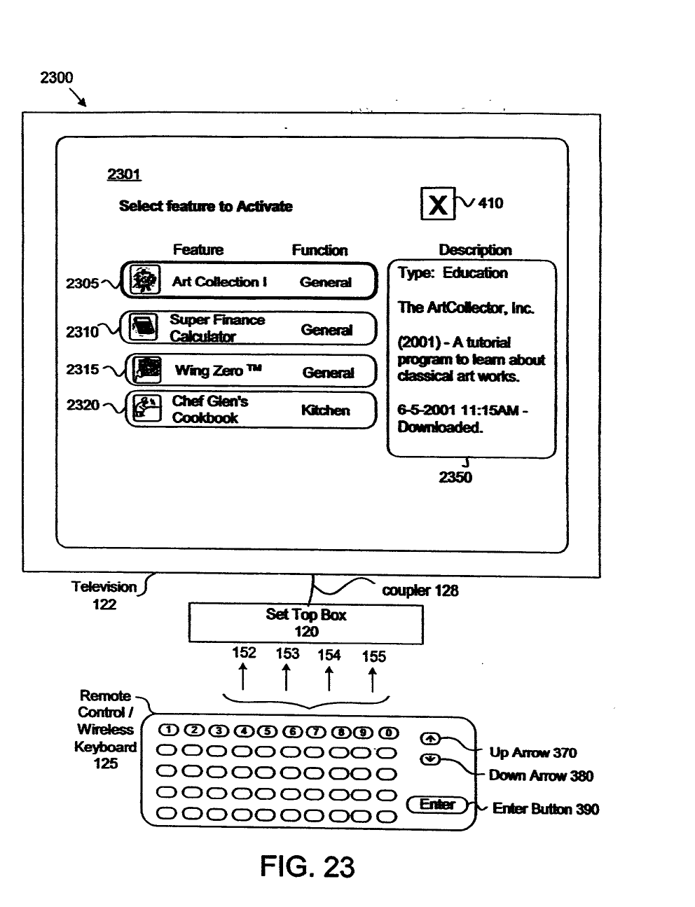

Referring now to FIG. 23, an example 2300 illustrates a list of triggerable events (applications 115) in an embodiment that are available to be added through the “other” feature in an embodiment of the home-style user interface. Each customizable feature listed on menu 2301 has an associated triggerable event already defined to home-style engine 116, which may be suitably stored in the set top box 120. On menu 2301, four customizable features are available as “other” features: Art Collection I 2305, Super Finance Calculator 2310, Wing Zero TM 2315, and Chef Glen's Cookbook 2320.

Each of these features has an associated icon, and a description of the feature that is displayed to correspond to a particular feature that is highlighted. The description provides the user of the home-style user interface with further information about the customizable feature. For instance, the description for the customizable Art Collection I feature 2305 provides information about the title of the feature or executable event (or the source of the associated executable event), a description of the feature (tutorial on classical art), versioning information (time and date), and the category or type of feature (or type of executable application associated therewith). Examples of types include game, financial application, communication, media player, etc. The type or category of feature (or associated executable event) assists the user to quickly identify the expectation for the use of the application Many times the title doesn't provide sufficient information for a user to determine what a feature might be, or is about. That is, the type or category of the feature helps the user with the identification and organization of a feature with respect to the different functions. This is especially useful if the list of available features is shared by when invoking the “other” feature from the settings menus for all functions.

Each customized feature also provides a suggested function that can suitably be employed by the user of the home-style user interface, as an indicator of to what function this customizable feature is suitably associated. For instance, the suggested function for the Chef Glen's Cookbook feature 2320 is the Kitchen function. The three other customizable features listed suggest a “general” function, meaning that these customizable features are suitably associated with multiple or many functions. The suggested function of Kitchen on the Chef Glen's Cookbook customized feature 2320 does not restrict the user of the home-style user interface from adding this feature to the living room. Instead, the suggested feature is merely suggestive of an appropriate function association.

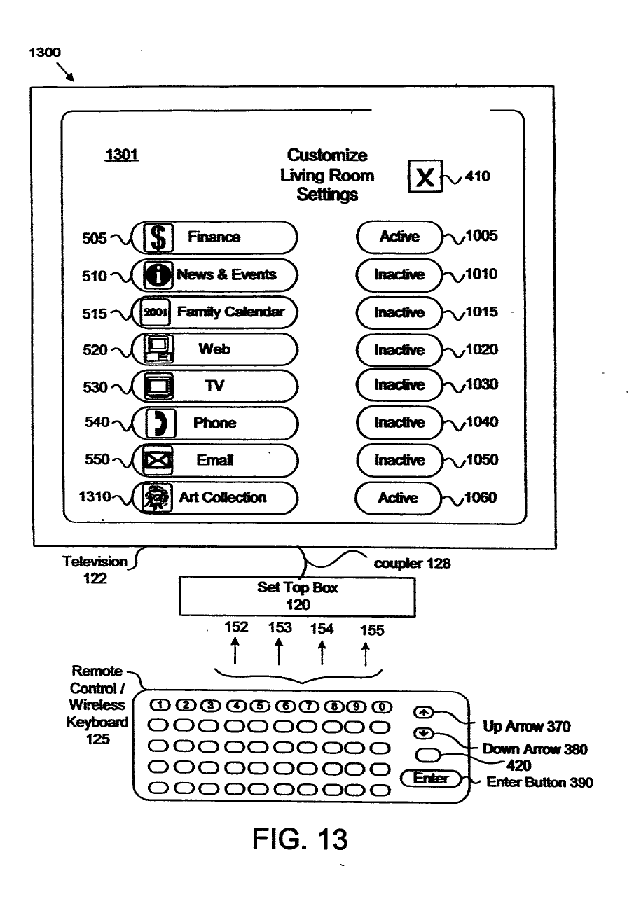

To add one of the listed features for the particular function (room), the user of interactive TV system selects the application (i.e. highlight the option using the up arrow button 370 and/or down arrow button 380 and then pressing the enter button 390), and Upon selecting option 2320, referring now to FIG. 13, the user is returned to the living room settings menu 1301 where the Art Collection feature 1310 and the corresponding activation/deactivation option 1060 are now displayed on the Customize Living Room Settings menu 1301. Correspondingly, home-style engine 216 sets setting 218 (living room other feature) in settings table 200 (see also Table 2) to active. This manner of customizing an “other” feature for a room is very easy for a user of the interactive TV system having little experience with personal computers and computer applications; because, all that a user has to do to add a customized feature to a function is select from a list of available features. This manner of customizing further provides additional information about each of the available customizable features, such as a suggested associated function, a description, and versioning information

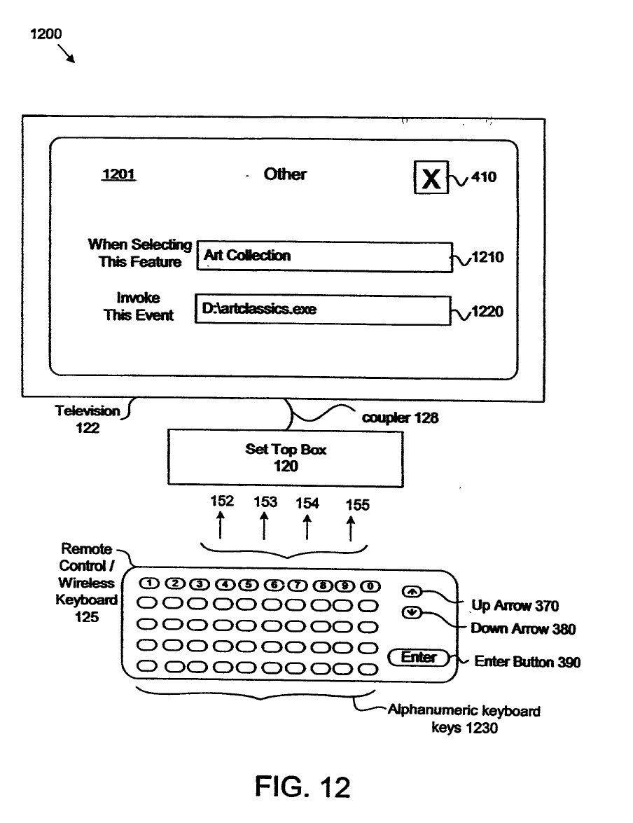

Referring now to FIG. 12, example 1200 illustrates an alternative method of permitting a user of home-style engine 116 to customize an “other” feature, such as the living room “other” feature 560, according to an embodiment of the invention. On menu 1201, the user of home-style system 116 is prompted to employ alphanumeric keyboard keys 1230 to enter a feature name in input field 1210 and a executable event, such as an application in input field 1220. By allowing the user to input a feature name (i.e. designate/choose a feature name), the home-style user interface provides additional customization capability. Further by allowing a user to input a command line for an executable event, the home-style user interface provides additional customization capability, in that the user is now able to invoke events that are outside what was delivered in the home-style user interface software product.

Alternatively, input field 1210 might operate as a drop down list of feature names and corresponding triggerable events. This alternative would share benefits with the method described above and illustrated in FIG. 23, in that with drop down lists, the user is not required to know the syntax for invoking a customized procedure. Additionally, the available features are already named.

The feature name 1210 is the feature name that appears on the function (room) menu (e.g., menu 1101 in FIG. 11), and the triggerable event (i.e. an application) is the file name (including path) or executable command line that will be invoked when the user of remote control device 125 subsequently selects the activated customized feature.

Suppose for instance that the user of iTV system 100 owns an art collection that is displayed on the walls of the living room Suppose that the user also owns a computerized tutorial program on classical art that he or she would like to invoke via iTV system 100. For this scenario, the user of iTV system 100 might want to add a customizable “other” feature (via option 1060) to the living room with the iTV system 100. To do so, the user of iTV system 100 selects the “other” add option 1060 and is presented with menu 1201 of example 1200 of FIG. 12. By employing the alphanumeric keyboard keys 1230, the user can type in the name of the feature (in field 1210) to be Art Collection. Alternatively, if the home-style interface already has this feature available as a customized feature (that is, has information about an associated triggerable event), the user might be able to select the name from a drop down list of names. Remote control device 125 transmits this information to set top box 120 via control signals 155. Control signals 155 collectively include a control signal for each of the keyboard keys 1230. For instance, signal 155a represents the “a” key; signal 155A represents the “A” key.

The feature name “Art Collection” is employed by home-style engine 116 to be associated with living room other setting 218 in settings table 200 (see also Table 2), and will be displayed as an active feature whenever the living room menu is displayed in an embodiment of the home-style user interface. In addition to the feature name, the user can employ the alphanumeric keyboard keys 1230 (or alternatively, a drop down list of triggerable events) to enter the name of the particular triggerable event (i.e. an executable application 115) to be associated with “Art Collection” and to be invoked by controller 104 when the user selects the “Art Collection” feature. In this example, the particular triggerable event is an executable tutorial application 115, which is invoked via the command “D\:artclassics.exe” which is what is entered into input field 1220. Remote control device 125 transmits this information to set top box 120 via control signals 155. The information about the associated triggerable event is also associated with living room other setting 218. When both the feature name (in field 1210) and the triggerable event command information (in field 1220) have been entered or identified, the customization of the other option 560 is complete, and (referring to FIG. 13) the user is returned to the living room settings menu 1301 where the Art Collection feature 1310 appears with an option 1060 that reflects that the feature is now active.

Although in one embodiment, the settings table provides storage for only one customizable feature per function, there could easily be many. For instance, settings information for a plentitude of customizable features may suitably be stored in a separate table. The information in the separate table may include the function name, which would provide the benefit of having all customizable features in a common storage area and flexibly assignable to whatever function that a user wants to customize. In this type of design, the other feature would suitably continue to appear on the settings menu, even after one customizable feature has been added to a function.

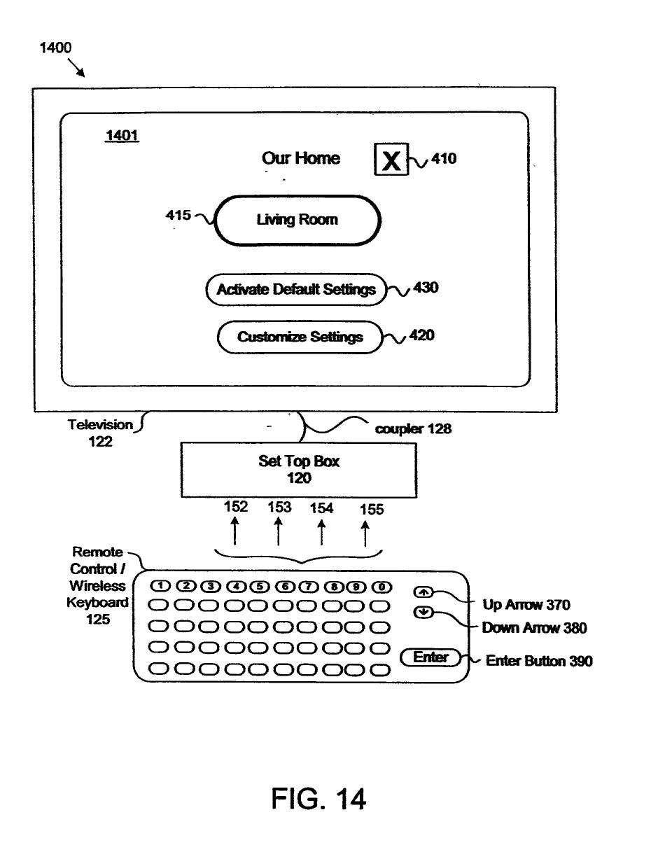

Referring the discussion back to preset features, the user of iTV system 100 may activate as many of the preset features as desired. Example 1300 shows two living room features as active (finance feature 505 and art collection feature 1310). When the user of iTV system 100 has activated all the desired living room features, the X option 410 may be employed to return to the higher-level menu (in this particular example, Customize Settings menu 901 in FIG. 9). When the user of remote control device 125 selects the X option 410, set top 120 displays the next higher-level menu 901 (FIG. 9). When the user of iTV system 100 has finished making settings changes, the user of remote control device 125 can select the X option 410, and set top box 120. Set top 120 then displays the next higher-level menu 1401 (FIG. 14).

Referring to FIG. 14, whenever the user of iTV system 100 activates one or more features in a function (as, for example, described above for the living room), the function (room) itself becomes active. That is, once a feature of a particular function (room) is active, the function (room) is active on the home-style menu. Example 1400 illustrates the home-style menu 1401 after one or more features have been activated in the living room. In this example, no other function (room) is displayed on the home-style menu 1401, because until now only living room function 415 has (a feature that has) been activated.

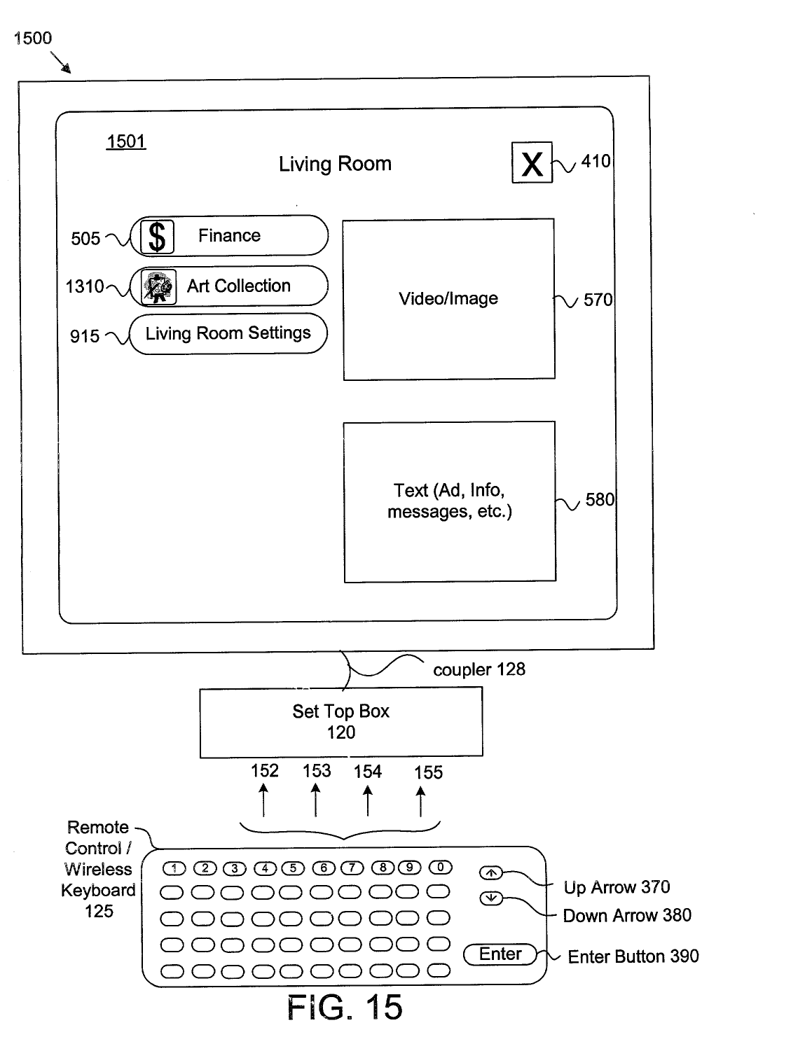

If the user of remote control device 125 selects the living room function 415 on example 1400 and presses the enter button 390, the remote control device 125 transmits control signal 154. Home-style engine 116 then queries the living room settings 210 (FIG. 2) to format and display the Living Room menu 1501 (FIG. 15). Example 1500 shows each of the active features (e.g., features 505 and 1310). Living Room Settings 915 can also be accessed from the Living Room menu 1501. Selecting Living Room Settings 915 invokes the Customize Living Room Settings menu (as shown in FIGS. 10, 11, and 13).

The Living Room menu 1501 also typically includes a video/image area 570, which operates similarly to a standard picture-in-picture image, to provide a video stream in addition to the display of the active room features. That is, the user of iTV system 100 can be, for example, watching TV or a video on the small TV/image area 570 within the larger living room menu 1501. Alternatively, an image may be displayed on area 570. In this manner, a video stream may be watched during the navigation and operation of the home-style user interface.

The Living Room menu 1501 also typically contains a text box 580 containing other types of displayable information, which is displayed in addition to the active living room features. For instance, text box 580 might contain an advertisement, messages, and/or other information. In this manner, text may remain stationary during the navigation between menus of the home-style user interface that contain a text box such as text box 580. Text box 580 also provides a suitable means to display “help” text for users of the home-style user interface, or to provide information associated with a highlighted feature (similar to the description text box 2350 on FIG. 23).

If the user of iTV system 100 selects finance feature 505 or any other present and active features, home-style engine 116 invokes the particular triggerable event (i.e. application 115) that is associated with the selected feature. If the user of iTV system 100 selects a customize feature, such as art collection feature 1310, home-style engine 116 invokes the particular application 115, that was either already associated with the Art Collection feature (if that information was available as in FIG. 23), or as entered by the user of the home-style user interface in text input field 1220 on FIG. 12. The previous series of examples has described how iTV system 100 allows a user to set up a home-style user interface that typically reflects features associated with particular environmental surroundings

Referring now again to FIG. 4, in example 400 there are active features in each of the nine functions (rooms) 415, 425, 435, 445, 455, 465, 475, 485 and 495 in the home menu 401. Selecting living room function 415 causes home-style engine 116 to query living room settings 210 (FIG. 2) in order to format and display the living room menu 1501 (FIG. 15). It is noted that FIG. 4 shows one example of a graphical representation of the functions 415, 425, 435, 445, 455, 465, 475, 485 and 495. The functions 415, 425, 435, 445, 455, 465, 475, 485 and 495 may also be shown in other forms such as pictures, icons, text, animation, video and/or in other graphical and/or textual representations or combinations of various types of representations. For instance, referring now to FIG. 24, example 2400 illustrates the Our Home 2401 represented in rough form as a residential floor plan. Each of the active functions 415, 425, 435, 445, 455, 465, 475, 485 and 495 are depicted as boxes, which can be highlighted and selected by pressing the enter button 390 to invoke the associated function menus. For instance, selecting the Living Room function 415 on menu 2401 prompts home-style engine 116 to format and display the living room menu 1501 (FIG. 15).

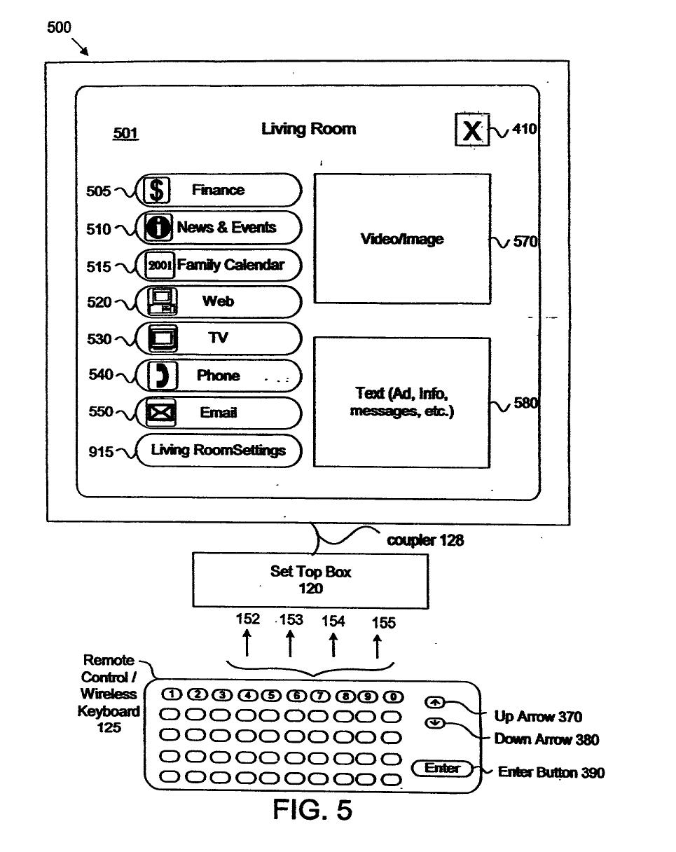

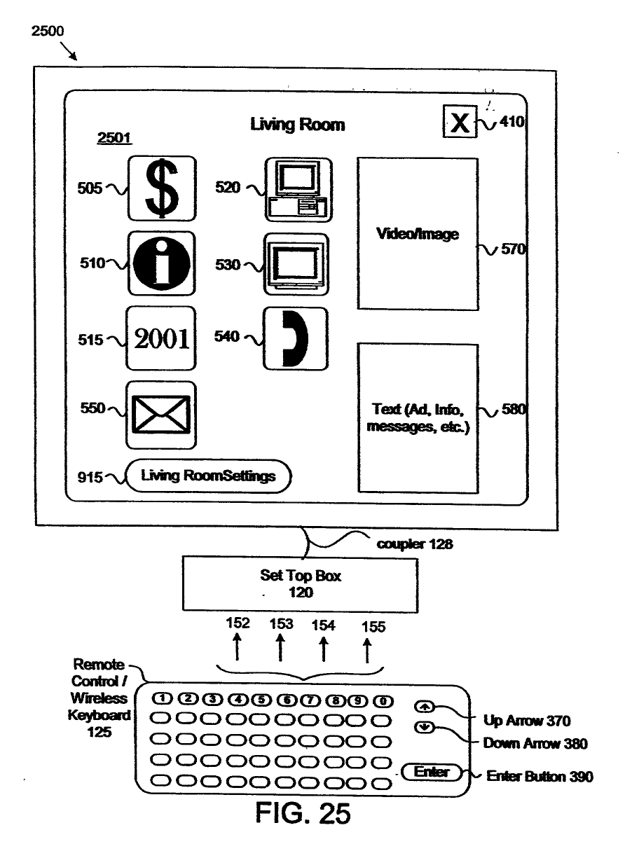

Referring now to FIG. 5, another example is shown of a living room menu 501 with seven (7) active features (i.e., features 505 to 550 and feature 915). The features enable various types of operations (executable events) as described in the above-mentioned examples. It is noted that FIG. 5 shows an example of a graphical representation of the features 505 to 550 and 915. Thus, the features 505 to 550 and 915 may be shown in the menu 501 in other forms such as pictures, icons, text, animation, video and/or other graphical and/or textual representations or combinations of various types of representations. For instance, referring now to FIG. 25, example 2500 illustrates an alternate manner of depicting the active living room features (505-550). Each of the icons can be highlighted and selected by pressing the enter button 390. Selecting any of the displayed features prompts home-style engine 116 to invoke the executable event associated with the feature.

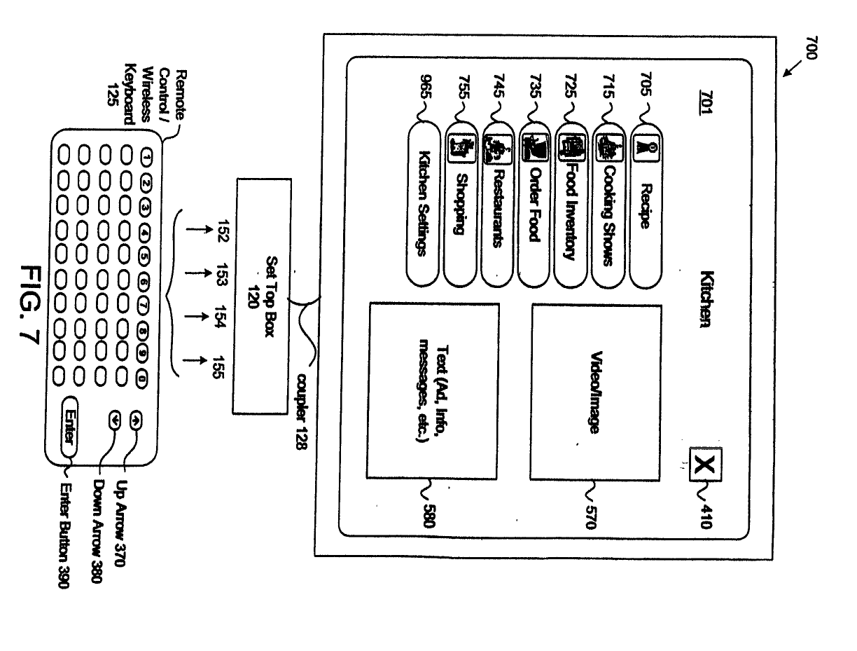

Alternatively and referring back to FIGS. 4 and 24, the user of iTV system 100 might alternatively select kitchen function 465 in home menu 401 or on menu 2401. Home-style engine 116 then queries kitchen settings 230 (FIG. 2) in order to format and display the kitchen menu 701 (FIG. 7). Example 700 shows six active features (705 to 755) and the kitchen settings option 965. If the kitchen function 465 on menu 401 is selected, then the user could, for example, be presented with menu selections related to various recipes (feature 705), television shows about cooking (feature 715), an electronic grocery list (feature 725), and/or the like. If, for example, the user selects a recipe (via feature 705), then an appropriate events (i.e. applications 115) are triggered so that the user may print the recipe, email the recipe, view an episode of a cooking show that teaches the selected recipe, and/or select at least another feature that relates to the selected recipe.

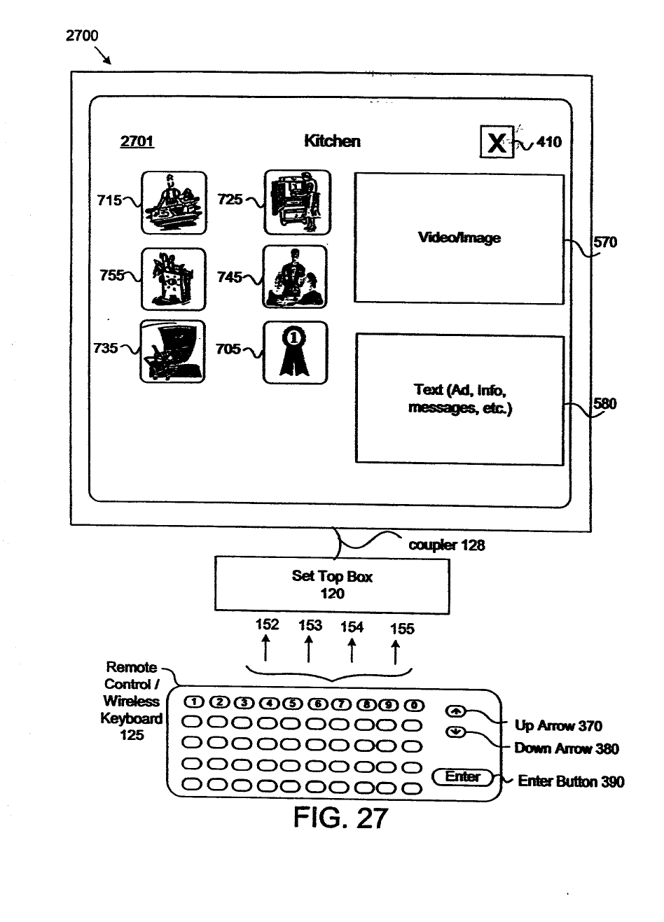

It is noted that FIG. 7 shows one example of a graphical representation of the features 705-755. The features 705-755 may be shown on the Kitchen menu in other forms such as pictures, icons, text, animation, video and/or other graphical and/or textual representations or combinations of various types of representations. For instance, referring now to FIG. 27, example 2700 illustrates an alternate manner of depicting the active kitchen features (705-755). Each of the icons can be highlighted and selected by pressing the enter button 390. Selecting any of the displayed features prompts home-style engine 116 to invoke the executable event associated with the feature.

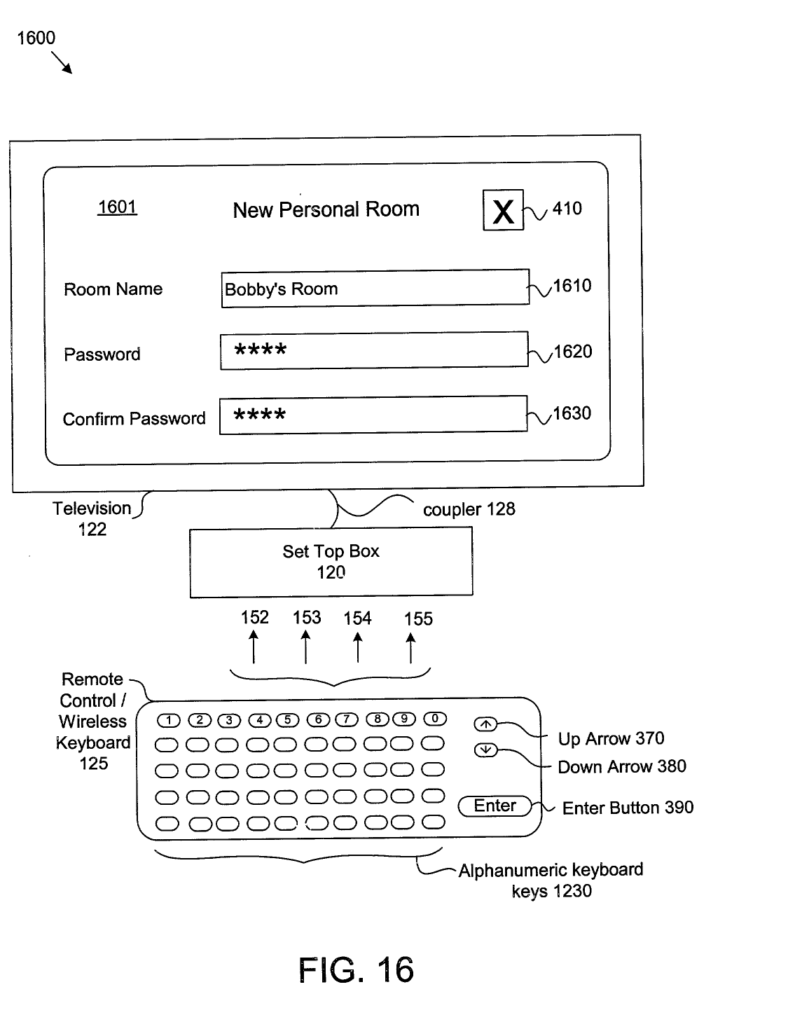

In an embodiment, both the living room and the kitchen are examples of common functions (or functions without any security settings). In an environment where there are multiple users of iTV system 100, it may be desirable to have security on certain functions (rooms) and/or certain features. In the illustrated embodiment, security is available in the setup of personalized functions/locations (or personalized rooms). Referring again to FIG. 9, a personalized and optionally secured function (room) can be created via personal room settings 945. If there are no personalized functions (rooms) yet identified, home-style engine 116 typically formats and displays a request for identification of a new specific personalized function (room) as shown in menu 1601 (FIG. 16).

Referring now to FIG. 16, example 1600 illustrates identification of a new personalized function (room). In this specific embodiment, the user of iTV system 100 is typically prompted for a function (room).name (in field 1610), and an optional password (in fields 1620 and 1630). Entering a password in fields 1620 and 1630 has the effect of restricting or denying access to the personalized function (restrict access to the location) to any user who does not enter the correct password, including denying access to all the features associated with the personalized room and the settings associated with those features.

Upon entering this information, home-style engine 116 stores the function (room) name and optional password information in setting table 200 (in the area of storage for Personal Room Settings). In one embodiment, a suitable mechanism exists for the situation where a password is forgotten. For example, there might be an additional input field on menu 1601, which prompts the user to input a question whose answer provides sufficient information for the user to determine the forgotten password. Alternatively or in addition, resetting the password might be a service offered by a local cable service provider.

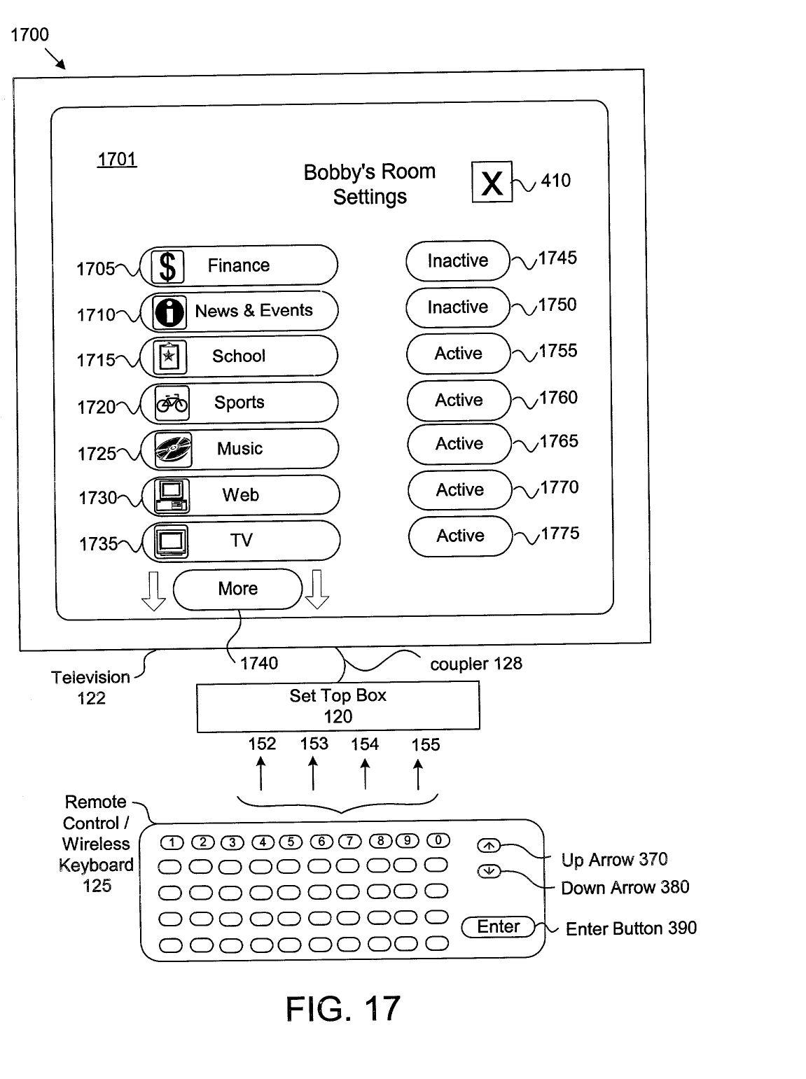

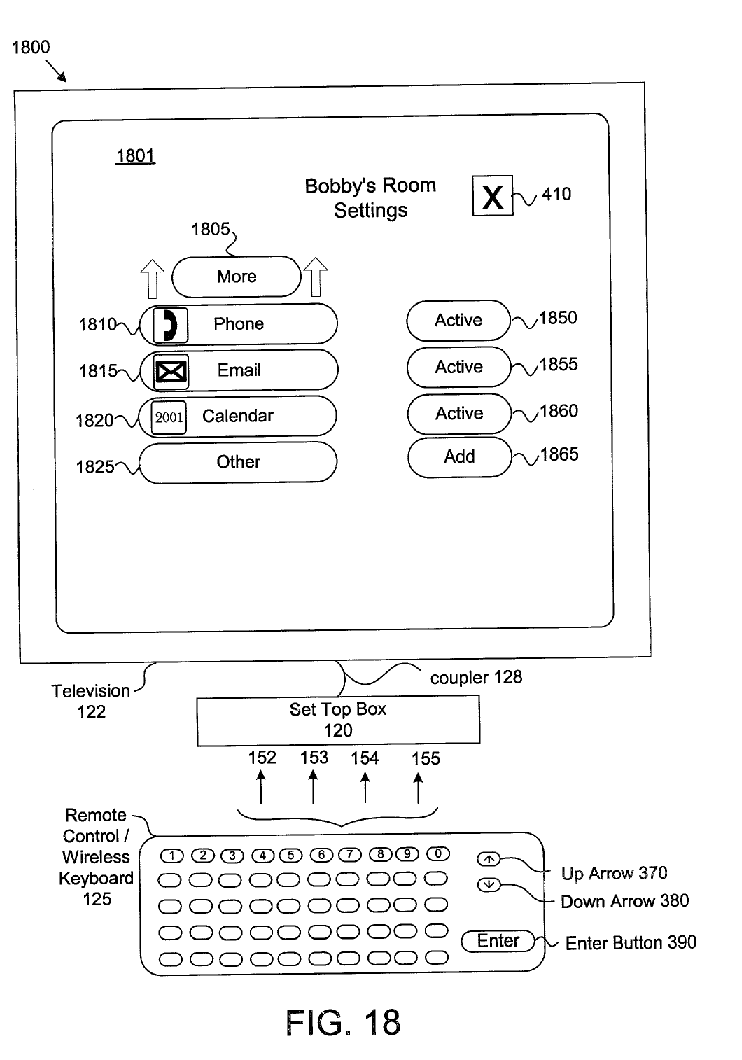

Referring now to FIGS. 17 and 18, examples 1700 and 1800 illustrate a settings menu for a personalized function (room). “More” options 1740 and 1805 allow the user of interactive TV system 100 to choose setup of more features than those that can fit on one screen. That is, selecting more option 1740 prompts home-style engine 116 to format and display the menu 1801 illustrated in example 1800. And selecting more option 1805 prompts home-style engine 116 to format and display the menu 1701 illustrated in example 1700.

Home-style engine 116 provides a list of preset features for any personalized function that the user of iTV system 100 can select to customize his or her personalized room. In an embodiment, these preset features include, for example, Finance feature 1705, News and Events feature 1710, School feature 1715, Sports feature 1720, Music feature 1725, Web feature 1730, TV feature 1735, Phone feature 1810, Email feature 1815, Calendar feature 1820, and/or Other feature 1825. At the product design level, at least one of the preset features may be omitted, and other features may be substituted in or included in the above-listed features. Each feature typically has a setting in settings table 200, as well as an active/inactive option (1745-1775 and 1845-1865) that reflects whether or not that feature is active. As explained with reference to setting up the living room, each of these features can be selectively activated. In this manner, personalized function (rooms) can be customized and features selected to be activated are associated with the person to which the personalized function belongs.

Further as described above with reference to the embodiment of the Customize Living Room Settings menu, all features are initialized to inactive. However still referring to FIGS. 17 and 18, as shown the user of interactive TV system 100 has already activated eight features (School feature 1715, Sports feature 1720, Music feature 1725, Web feature 1730, TV feature 1735, Phone feature 1810, Email feature 1815, and Calendar feature 1825. Once the user has finished selectively activating the features for his personalized function (room), the X option 410 may be employed to return to the home-style settings menu (FIG. 9).

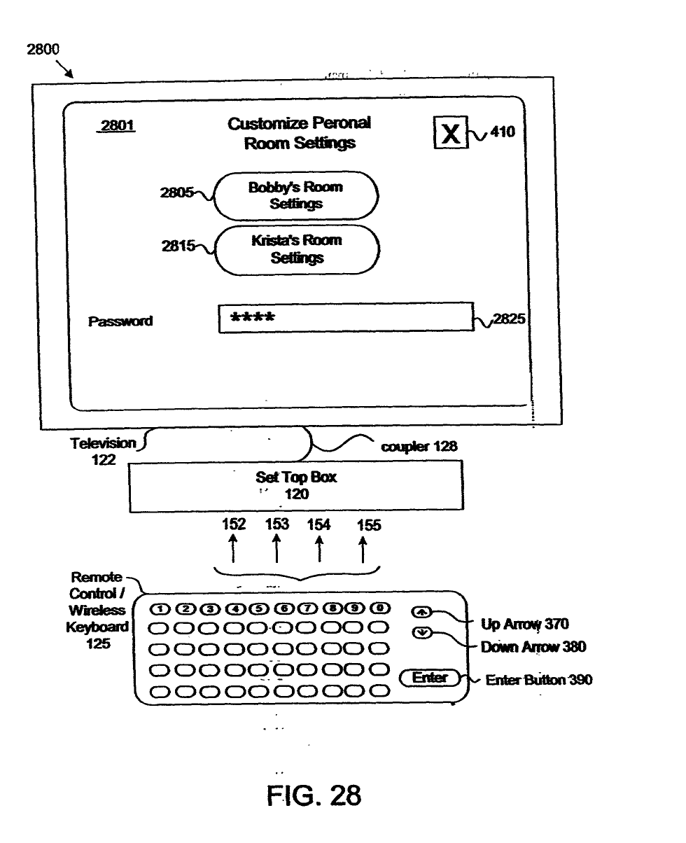

Referring again to FIG. 9, once one or more personalized functions have been setup, then selecting the personal room settings option 945 would prompt home-style engine 116 to display a personalized settings screen, as shown in example 2800 of FIG. 28. Once rooms, such as Bobby's Room and Krista's Room have been set up the first time (i.e. as in the example sequence shown in FIGS. 16-18), then the next time that a user invokes the personal room settings option 945 on menu 901, home-style engine 116 displays a menu that provides settings options for the the personalized rooms in existence. Thus in example 2801, it can be seen that Bobby's Room and Krista's Room have already been set up.

To update the settings in an existing personalized room, such as Bobby's Room, a user selects the Bobby's Room Settings option 2805. If Bobby's Room is password-protected, then home-style engine 116 will require verification input in field 2825, before formatting and displaying the Bobby's Room Settings menu (shown in FIGS. 17 and 18). In this manner, settings cannot be adjusted for an access-restricted location without verification input.

Referring again to FIG. 9, the user of interactive TV system 100 might also choose to activate particular features in the kitchen by selecting the kitchen settings option 965, which invokes a Customize Kitchen Settings menu (not shown) The Customize Kitchen Settings menu operates similarly to the Customized Living Room Settings menu, as described above. After activating particular features in the Kitchen, the user can return to home-style settings screen menu 901 shown in example 900. Once the user has finished activating features in the different functions (rooms), option 410 on menu 901 is selected to return to the home-style menu 2001.

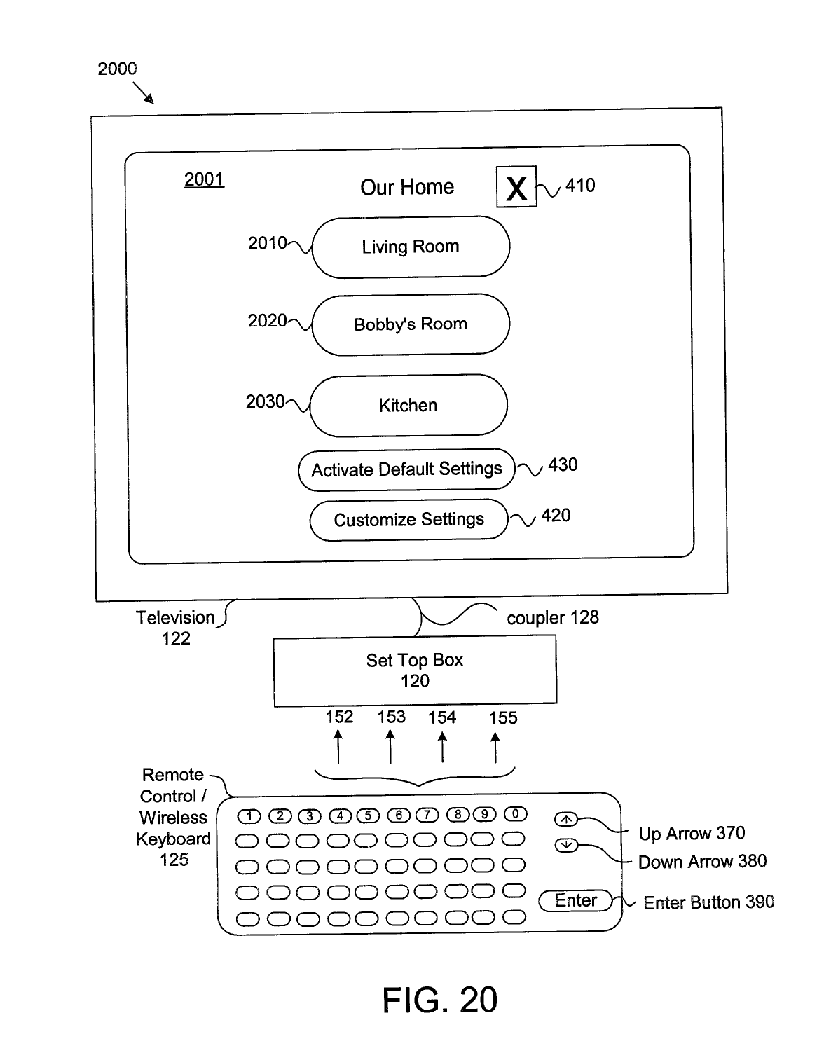

Referring now to FIG. 20, example 2000 displays on the home-style menu 2001 three functions (Living Room function 2010, Bobby's Room function 2020, and Kitchen function 2030). In the sequence of examples that have been presented (FIGS. 8 through 18 and 23), features have been activated in these three rooms (2010, 2020, and 2030) only. Because an embodiment of interactive TV system 100 is designed to display only functions for which associated features are active, menu 2001 displays only these three functions (2010, 2020, and 2030). Thus, menu 2001 reflects the Our Home menu, after it has been customized by the user to have active features associated with three functions/locations.

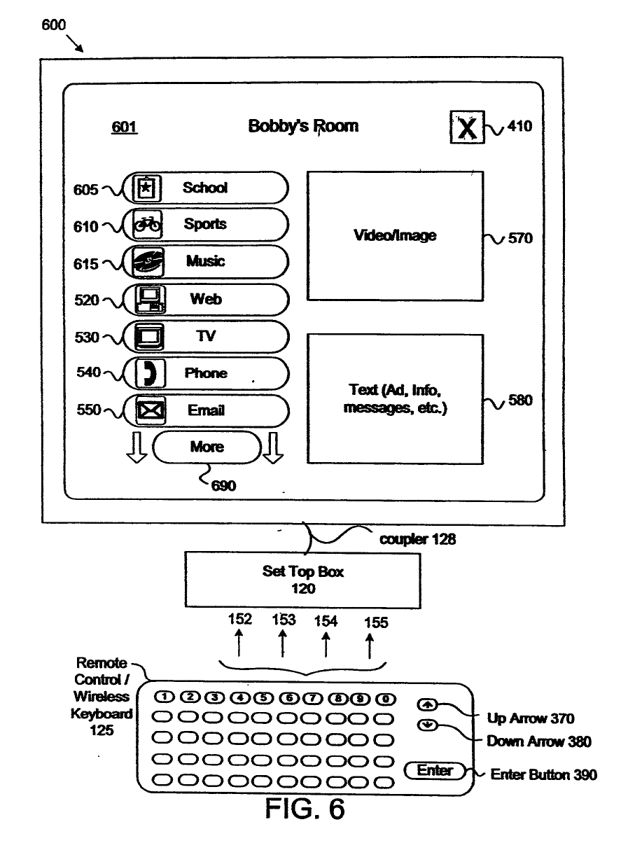

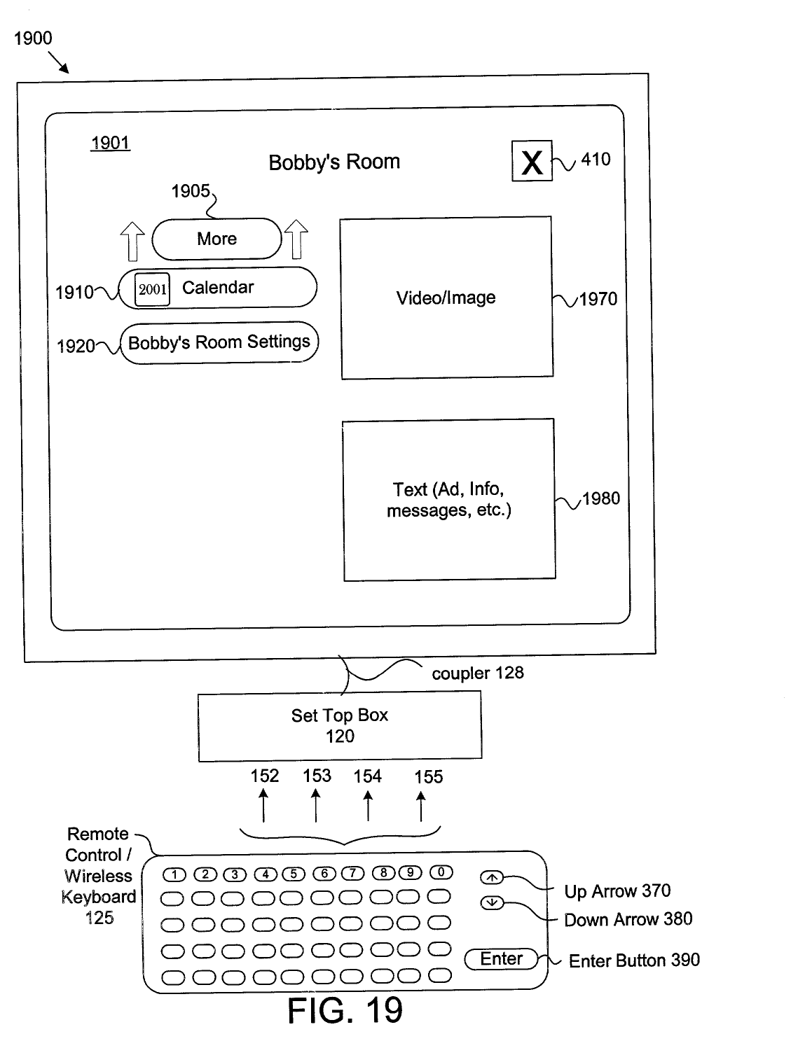

Selecting living room function 2010 from the Our Home menu 2001 prompts home-style engine 116 to typically display the active living room features 505 and 1310 illustrated in FIG. 15. Similarly, on menu 2001, selecting Bobby's Room function 2020 or Kitchen function 2030 prompts home-style engine 116 to typically display the active features in Bobby's room function (menu 601 in FIG. 6, and menu 1901 in FIG. 19) and the active features in the Kitchen function (menu 701 in FIG. 7), respectively.

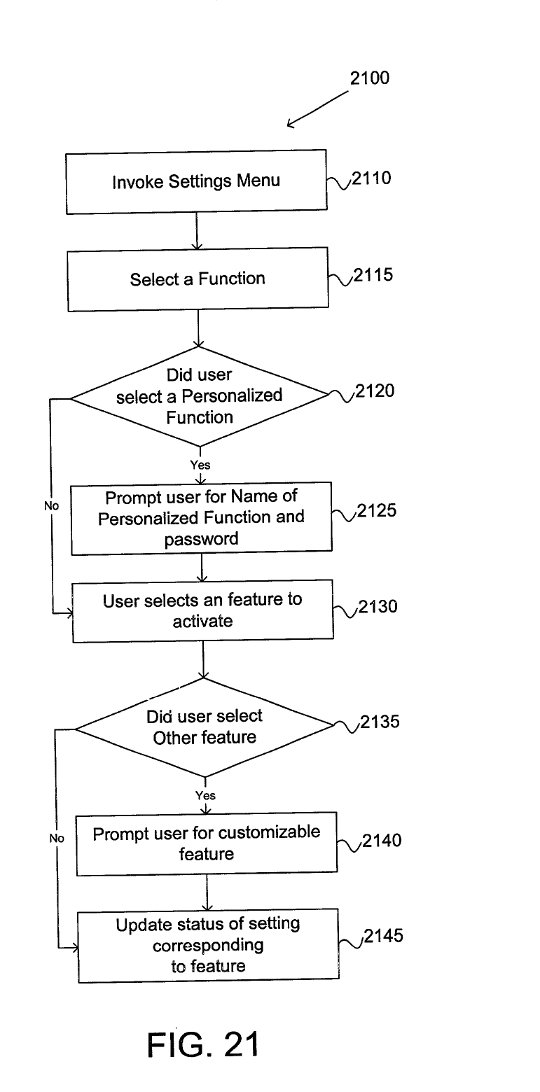

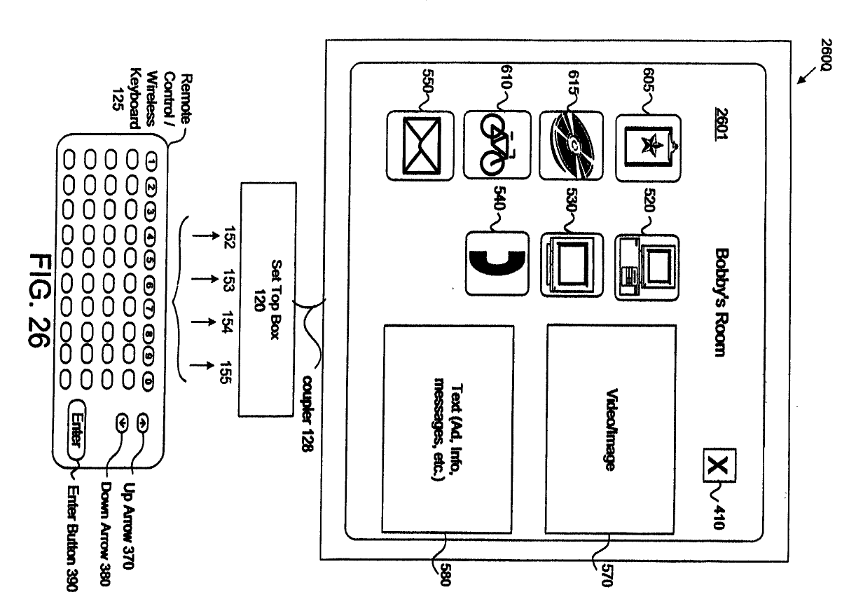

Although FIGS. 2 through 20 and 23-28 illustrate a particular embodiment of the invention that is directed to the surrounding locations of a house, the present invention is adaptable to organizing functions in a manner that resembles other types of surrounding locations and environments. To provide a more generalized example of the setup and operation of an embodiment of the home-style user interface, reference is now made to FIG. 21. To activate a feature associated with a particular function (i.e. a location), the user of interactive TV system 100 typically first invokes a settings menu (block 2110). In one embodiment, the settings menu has a number of preset functions that can be selected, as well as a personalized function. The user of iTV system 100 selects a function for which to activate one or more features (block 2115). If the selected function is a personalized function (Yes to block 2120), then the user of interactive TV system 100 is prompted for a personalized function name and a password, which is entered optionally to restrict access to the personalized function (block 2125).

Typically, each of the function settings menus available in an embodiment of interactive TV system 100 have a number of preset features, as well as an “Other” feature. In an embodiment, all features for a particular function are initialized to inactive. The user of iTV system 100 can select an option associated with each feature to toggle the state of that feature from active to inactive (block 2130). If the user selects an “Other” feature (Yes to block 2135), home-style engine 116 prompts the user for more information to identify information about the event (block 2140) that should be triggered whenever the activated feature is selected by a user of iTV system 100. The “Other” feature provides the user of interactive TV system 100 with the capability of customizing the home-style user interface beyond the preset features provided for each preset function.

Home-style engine 116 typically does not need additional information about the triggerable event (i.e. a feature name or the directory path of an executable application 115) for preset features with the exception of one embodiment where selecting the Other feature prompts the user to enter a command line or file name of a-triggerable event, because home-style engine 116 already has that information for preset features as well as customizable features that are already identified to home-style engine 116.

Home-style engine 116 tracks which features are active or inactive, and updates the settings table accordingly (block 2145).

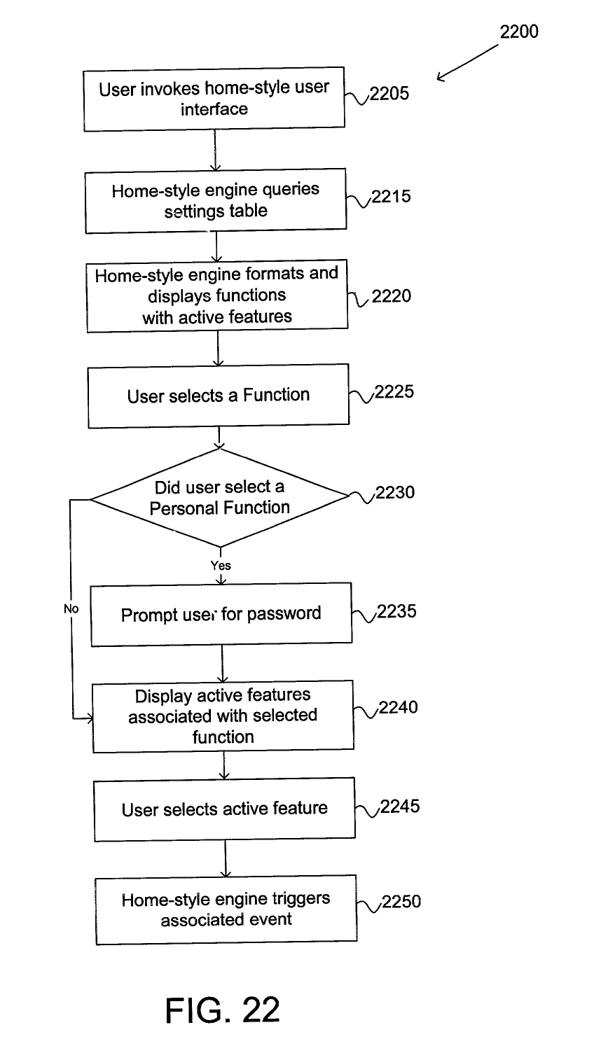

Referring now to FIG. 22, flowchart 2200 illustrates an operation of an embodiment of interactive TV system 100. Upon turning on the interactive TV system 100 (block 2205), home-style engine 116 formats and displays a high-level menu that typically includes an option to display a list of functions (i.e. surrounding locations). In order to decide the particular functions to display on the list, home-style engine 116 queries the settings table 200 (block 2215) to determine which functions are active or inactive. If at least one of the features for a particular function is active, then the function is considered active and is displayed on the list (block 2220).

From the list of active functions, the user of iTV system 100 can select one of the active functions (block 2225). Home-style engine determines whether the selected function is a personalized function (block 2230). If so (Yes on Block 2230), home-style engine 116 prompts the user of iTV system 100 for a password for the personalized function (block 2235). If the user enters the correct password, then the home-style engine proceeds to block 2240. Access to a password-protected function will typically be denied if the user cannot enter the correct password.

In one embodiment, from the settings table 200, home-style engine 116 determines which features for a particular function are active. Home-style engine 116 formats and displays the active features for the selected function (block 2240). The user of interactive TV system 100 can select from any of the active features (block 2245).

Still referring to FIG. 22, when the user of interactive TV system 100 selects an active feature associated with a particular function (block 2245), home-style engine 116 retrieves information from storage about the triggerable event (i.e. executable application 115). Home-style engine 116 then triggers the appropriate event (block 2250).

Flowcharts 2100 and 2200 can also be used to illustrate a method of setting up an embodiment of the interactive TV system 100 as described in FIGS. 2-20, and 23-28, where each of the functions are rooms/locations in a household. To setup up such an embodiment of the customized home-style user interface, a user of interactive TV system 100 selects the Our Home option from the home-style menu (FIGS. 4, 8, 14, 20, and 24). The Our Home menu displays rooms that have active features, which is why, for example, different rooms appear in each of the referenced examples (400, 800, 1400, 200 and 2400). The embodiment may have software product defaults such that certain predetermined features in one or more of the rooms are initialized to active. In that case, the Our Home menu will initially display those rooms that have one or more features that default to active (as in examples 400 and 2400). In an alternate embodiment, none of the features default to active and in that case, the Our Home menu initially appears without displaying any rooms (as in example 800). As features are activated in the various rooms via the room settings menus, those rooms become active and the Our Home menu displays the active rooms.

To activate a feature in a particular room, the user of interactive TV system 100 first selects the corresponding room settings menu. One method of invoking a particular room settings menu is via Customize Settings option 420 on the Our Home menu (block 2110), which invokes the Customize Settings menu 901 (FIG. 9). The Customize Settings menu 901 typically has a number of preset rooms to choose from, as well as a personalized room. The user can select a room in which to activate features (block 2115). If the room selected is a personalized room (Yes to block 2120), then the user of interactive TV system 100 is prompted for a room name (in field 1610) and a password (in field 1620) (FIG. 16), which optionally provides secured access to the room and its features.

Typically, each of the room settings menus available in an embodiment of interactive TV system 100 have a number of preset features, as well as an “Other” feature, as shown in examples 1000, 1100, and 1800 (FIGS. 10, 11 and 18, respectively). The user can toggle the state of a feature from active to inactive by selecting the associated active/inactive option (block 2130). If the user selects an “Other” feature (Yes to block 2135), home-style engine 116 prompts the user for more information to identify more specifics about the feature and which event to trigger when this “Other” option is activated and accessed subsequently from the corresponding room menu (such as Art Collection 505 on the Living Room menu 1501). This additional information might be available from a list of customizable features with corresponding triggerable events that are already available on set top box 120 and defined to home-style engine 116, as in FIG. 23, or this information might include the provision of fields to allow a user to input a feature name and a corresponding triggerable event (i.e. a directory path of an executable application 115) (block 2140), as shown in example 1200 (FIG. 12). Thus, the “Other” option provides the user of interactive TV system 100 with the capability of customizing the home-style user interface beyond the preset features available by default in the different rooms.

Home-style engine 116 typically does not need the additional information (a feature name or the directory path of an executable application 115) for preset features with the exception of certain embodiments of the “Other” feature, because a preset event (i.e. an executable application) is typically already associated with a particular feature.

Home-style engine 116 tracks which features in each room are active or inactive, and updates the settings table 200 accordingly (block 2145).

Reference is again made to FIG. 22 to describe an example of a method of operation of an embodiment of the interactive TV system 100, where the functions are rooms/locations in a household. Upon turning on the interactive TV system 100, home-style engine 116 formats and displays the high-level menu 301 shown in example 300 (FIG. 3). One of the options provided to the user of an embodiment of interactive TV system 100 is to display the Our Home menu (block 2205), as shown in FIGS. 4, 8, 14, 20 and 24. In order to determine the rooms to display on the Our Home menu, home-style engine 116 queries the settings associated with each room in settings table 200 (block 2215) to determine which features in each room are active and which features in each room are inactive. Only active rooms (i.e. those that have active features) are displayed on the Our Home menu. Referring now to FIG. 2, in one embodiment the settings table 200 includes a plurality of settings for each of the preset rooms (e.g., Living Room settings 210, AV room settings 220, Kitchen settings 230, Garage settings 240, Garden settings 250, and/or Gym settings 260), as well as one or more personalized room settings (e.g., personal room 1 settings 270, personal room 2 settings 280 through personal room X settings 290).

Home-style engine 116 queries each of the settings in the settings table 200 to determine if any of the features in any of the rooms are active. If at least one of the features is active, then the associated room is considered active and displayed on the Our Home menu. For example, home-style engine 116 queries the living room settings 200 to determine if any of the features in Living Room settings 210 (settings 211 through 218) is active. If at least one feature is active, then the living room is considered active and displayed on the Our Home menu.

Each active room is then displayed on the Our Home menu (block 2220), examples of which can be seen in FIGS. 4, 8, 14, 20 and 24. From the Our Home menu, the user can select a room (block 2225). Home-style engine 116 determines if the selected room is a personalized room (block 2230). If so (Yes on block 2230), home-style engine 116 determines if the room is secured and if it is, prompts the user for a password for the personalized room (block 2235). If the user enters the correct password, then home-style engine 116 proceeds to block 2240. Access to a password-protected personalized room will typically be denied if the user cannot enter the correct password.

From the settings table 200, home-style engine 116 determines which features within a particular room are active. Home-style engine 116 formats and displays the active room features on the room menu (block 2240). Examples 500, 600, 700, 1500, 1900, 2500, 2600, and 2700 (FIGS. 5, 6, 7, 15, 19, 25, 26 and 27, respectively) are illustrative of particular room menus. The user of interactive TV system 100 can select any of the room features (block 2245). Alternatively, the user of an embodiment of interactive TV system 100 can access the settings menu for a particular room via the settings button.

For example, Living Room Settings 915 appears in example 1500 (FIG. 15), along with the other active living room features (finance feature 505, and art collection feature 1310). Selecting Living Room Settings 915 will take the user of interactive TV system 100 to, for example, the Customize Living Room Settings menu 1301 (FIG. 13).

Still referring to FIG. 22, when the user of interactive TV system 100 selects a feature other than the settings option (block 2245), home-style engine 116 queries the setting table 200 for information associated with the selected features and determines the event to trigger. Home-style engine 116 then triggers the appropriate event (block 2250).

Other variations and modifications of the above-described embodiments and methods are possible in light of the foregoing teaching. For example, the interactive television might be located in a resort and the function (surrounding locations) might include the different amenities at the resort. A personalized function might be a resort guest's room, and might include features such as email or voice mail, or information about the resort guest's bill.

As another example, instead of using a password to restrict access to a personalized function, password protection might be implemented at the feature level. Further, other methods of security may be used for securing both functions and features, such as, for example, fingerprint identification, voice identification, and/or other types of security access codes or verification or security methods.

Further, at least some of the components of this invention may be implemented by using a programmed general-purpose digital computer, by using application specific integrated circuits or field programmable gate arrays, or by using a network of interconnected components and circuits. Connections may be wired, wireless, by modem, and the like.

It is also within the scope of the present invention to implement a program or code that can be stored in an electronically-readable medium to permit a computer to perform any of the methods described above.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of executing an event in an interactive television system, the method comprising:
associating a function with a location in an environment of the interactive television system; and
in response to a selection of the function, enabling an event associated with the function.

2. The method of claim 1 wherein the function includes at least one feature associated with the location.

3. The method of claim 2 wherein enabling the event comprises:
selecting one of the features to execute an application associated with the feature.

4. The method of claim 2 wherein enabling the event comprises:
selecting one of the features to provide information associated with the feature.

5. The method of claim 1, further comprising:
requiring verification input if the location is a restricted location.

6. The method of claim 1 wherein prior to enabling the event, determining if the function has an active status.

7. The method of claim 2, further comprising:
customizing a feature in one of the functions.

8. The method of claim 2, further comprising:
setting the feature in one of active state or inactive state.

9. The method of claim 2 wherein additional video is displayed with a representation of the feature or function.

10. The method of claim 2 wherein additional text is displayed with a representation of the feature or function.

11. The method of claim 1, further comprising:
creating a personal room function associated with a restricted-access location in the environment of the interactive television system.

12. The method of claim 11, further comprising:
activating at least one feature associated with the personal room function.

13. An article of manufacture, comprising:
a machine-readable medium having stored thereon instructions to:
associate a function with a location in an environment of the interactive television system; and
in response to a selection of the function, enable an event associated with the function.

14. An apparatus for executing an event in an interactive television system, the apparatus comprising:
means for associating a function with a location in an environment of the interactive television system; and
communicatively coupled to the associating means, means for enabling an event associated with the function, in response to a selection of the function.

15. A method of organizing information in an interactive television system, the method comprising:
displaying a function that is associated with a location in an environment of the interactive television system; and
in response to a selection of the function, enabling an event associated with the function.

16. The method of claim 15 wherein the function includes at least one feature associated with the location.

17. The method of claim 16 wherein enabling the event comprises:
selecting one of the features to execute an application associated with the feature.

18. The method of claim 16 wherein enabling the event comprises:
selecting one of the features to provide information associated with the feature.

19. The method of claim 15, further comprising:
requiring verification input if the location is a restricted location.

20. The method of claim 15 wherein prior to enabling the event, determining if the function has an active status.

21. The method of claim 16, further comprising:
customizing a feature in one of the functions.

22. The method of claim 16, further comprising:
setting the feature in one of active state or inactive state.

23. The method of claim 16 wherein additional video is displayed with a representation of the feature or function.

24. The method of claim 16 wherein additional text is displayed with a representation of the feature or function.

25. The method of claim 15, further comprising:
creating a personal function associated with a restricted-access location in the environment of the interactive television system.

26. The method of claim 25, further comprising:
activating at least one feature associated with the personal function.

27. An article of manufacture, comprising:
a machine-readable medium having stored thereon instructions to:
associate a function with a location in an environment of the interactive television system; and
in response to a selection of the function, enable an event associated with the function.

28. An apparatus for executing an event in an interactive television system, the apparatus comprising:
means for associating a function with a location in an environment of the interactive television system; and
communicatively coupled to the associating means, means for enabling an event associated with the function, in response to a selection of the function.

29. A method of organizing information in an interactive television system, the method comprising:
selecting a settings menu that includes at least one function corresponding to a location in an environment of the interactive television system;
selecting one of the functions in the settings menu;
if the selected function corresponds to a personalized location, then requiring a verification input, and if the verification input is valid, then permitting a feature in the selected function to be activated;
if the selected function does not correspond to a personalized location, their permitting a feature in the selected function to be activated; and
if the activated feature is a customizable feature, then permitting input of a name for the activated feature and a directory path to an application associated with the activated feature.

30. An article of manufacture, comprising:
a machine-readable medium having stored thereon instructions to:
select a settings menu that includes at least one function corresponding to a location in an environment of the interactive television system;
select one of the functions in the settings menu;
if the selected function corresponds to a personalized location, then require a verification input, and if the verification input is valid, then permit a feature in the selected function to be activated;
if the selected function does not correspond to a personalized location, then permit a feature in the selected function to be activated; and
if the activated feature is a customizable feature, then permit input of a name for the activated feature and a directory path to an application associated with the activated feature.

31. An apparatus for organizing information in an interactive television system, the apparatus comprising:
means for selecting a settings menu that includes at least one function corresponding to a location in an environment of the interactive television system;
communicatively coupled to the means for selecting the settings menu, means for selecting one of the functions in the settings menu;
communicatively coupled to the means for selecting one of the functions, means for requiring a verification input if the selected function corresponds to a personalized location and for permitting a feature in the selected function to be activated if the verification input is valid;
communicatively coupled to the means for selecting one of the functions, means for permitting a feature in the selected function to be activated if the selected function does not correspond to a personalized location; and
communicatively coupled to the means for permitting the feature, means for permitting input of a name for the activated feature and a directory path to an application associated with the activated feature if the activated feature is a customizable feature.

32. A method of processing information in an interactive television system, the method comprising:
checking a settings table to determine active functions and inactive functions, the active functions and the inactive functions corresponding to associated locations in an environment of the interactive television system;
displaying each active function;
selecting one of the active functions;
if the selected active function is a personalized function corresponding to a personal location, then requiring a verification input, and if the verification input is valid, then displaying at least one active feature associated with the selected active function;
if the selected active function is not a personalized function, then displaying at least one active feature associated with the selected active function; and
selecting at least one of the active features and enabling an event associated with the selected active feature.

33. An article of manufacture, comprising:
a machine-readable medium having stored thereon instructions to:
check a settings table to determine active functions and inactive functions, the active functions and the inactive functions corresponding to associated locations in an environment of the interactive television system;
display each active function;
select one of the active functions;
if the selected active function is a personalized function corresponding to a personal location, then require a verification input, and if the verification input is valid, then display at least one active feature associated with the selected active function;
if the selected active function is not a personalized function, then display at least one active feature associated with the selected active function; and
select at least one of the active features and enabling an event associated with the selected active feature.

34. An apparatus for processing information in an interactive television system, the apparatus comprising:
means for checking a settings table to determine active functions and inactive functions, the active functions and the inactive functions corresponding to associated locations in an environment of the interactive television system;
communicatively coupled to the checking means, means for displaying each active function;
communicatively coupled to the displaying means, means for selecting one of the active functions;
communicatively coupled to the selecting means, means for requiring a verification input if the selected active function is a personalized function corresponding to a personal location and for displaying at least one active feature associated with the selected active function if the verification input is valid;
communicatively coupled to the selecting means, means for displaying at least one active feature associated with the selected active function if the selected active function is not a personalized function; and
communicatively coupled to the selecting means, means for selecting at least one of the active features and for enabling an event associated with the selected active feature.

35. An apparatus for enabling a user interface in an interactive television system, the apparatus comprising:
a set top box communicatively coupled to the display device and capable to transmit television signals to a display devices the set top box including a user interface engine capable to display a function associated with a location in an environment of the interactive television system;
the set top box further including a controller capable to execute the user interface engine and to enable an event in response to a selection of the function.

36. The apparatus of claim 35 wherein the function includes at least one feature associated with the location.

37. The apparatus of claim 36 further comprising: an application associated with the feature, the controller executing the application in response to a selection of the feature.

38. The apparatus of claim 36 wherein selection of the feature provides information associated with the selected feature.

39. The apparatus of claim 36 wherein the user interface engine is capable to check for a verification input if the selected function is associated with a restricted location.

40. The apparatus of claim 36 wherein the user interface engine is capable to set a feature in active state or inactive state.

41. An apparatus for enabling a user interface in an interactive television system, the apparatus comprising:
a remote control device capable to transmit command signals;
a controller; and
a user interface engine executable by the controller in response to command signals from the remote control device to permit access to a function associated with a location in an environment of the interactive television system.

42. The apparatus of claim 41 wherein the controller is capable to trigger an event associated with the function in response to a selection of the function.

43. An apparatus for providing to a user of an interactive television system, a home style user interface that is organized according to a plurality of the user's surrounding locations, the apparatus comprising:
a set top box including a storage capable to store information associated with each of a plurality of features, each feature associated with one of the plurality of locations, the set top box further capable to receive and interpret a command signal and capable to format a television screen layout from the interpreted command signal and capable to transmit the television screen layout;
a television including a television screen, the television communicatively coupled to the set top box and capable to receive the television screen layout from the set top box and capable to display the television screen layout on the television screen; and
a user input device communicatively coupled to the set top box and capable to capable to detect a user input and capable to convert the user input into the command signal and transmit the command signal to the set top box.

44. The apparatus of claim 43 wherein the plurality of locations is a plurality of rooms in a building.

45. The apparatus of claim 43 wherein the plurality of locations is a plurality of rooms in a dwelling.

46. The apparatus of claim 43 wherein the information associated with each feature includes indicia of whether the feature is active or inactive.

47. The apparatus of claim 43 wherein the set top box is further capable to update the indicia of whether the feature is active or inactive based upon the command signal received from the user input device.

48. The apparatus of claim 43 wherein the information associated with each feature includes information about an executable application that is invoked when the feature is active and when the user selects the feature.

49. The apparatus of claim 43 wherein the set top box is further capable to update the information about an executable application based upon the command signal received from the user input device.

50. The apparatus of claim 43 wherein the set top box storage is further capable to store a name associated with one of the locations.

51. The apparatus of claim 43 wherein the set top box is further capable to update the name associated with the location.

52. The apparatus of claim 43 wherein the set top box storage is further capable to store indicia of whether at least one of the plurality of locations is password protected.

53. The apparatus of claim 43 wherein the set top box storage is further capable to store a password associated with one of the plurality of locations.

54. The apparatus of claim 43 wherein the set top box is further capable to provide user access to each of the plurality of features associated with one of the plurality of locations that is password protected, if the interpretation of the command signal received from the user input device results in a determination that the user has entered the password associated with the one of the plurality of locations.

55. The apparatus of claim 43 wherein the information associated with each of a plurality of features is stored in a settings table comprising a plurality of table entries, each table entry associated with one of the plurality of features and further associated with one of the plurality of locations.

56. The apparatus of claim 43 wherein: the set top box is further capable to:
determine which of the plurality of features are active; and
format the television screen layout to include features of the plurality of features that are active.

57. The apparatus of claim 43 wherein the set top box is further capable to:
determine which features of the plurality of features are associated with one of the plurality of locations;
determine which features of the plurality of features associated with the one of the plurality of locations are active; and
format a television screen layout including those features associated with the one of the plurality of locations that are also active.

58. A method of providing a home-style user interface to a user of an interactive television system, the method comprising:
displaying at least one active feature associated with one of a plurality of the user's surrounding locations;
accepting user input including a selection of one of the at least one active feature; and
invoking an executable application associated with the selected active feature.

59. The method of claim 58, further comprising:
displaying indicia of each of the plurality of locations that has at least one associated active feature; and
accepting user input including a selection of indicia for one of the plurality of locations that has at least one associated active feature;
and wherein:
the displaying of the indicia of each of the plurality of active features comprises displaying each active feature associated with the selected one of the locations.

60. An article of manufacture, comprising:
a machine-readable medium having stored thereon instructions to:
display at least one active feature associated with one of a plurality of a interactive television system user's everyday surroundings;
accept user input including a selection of one of the at least one active feature; and
invoke an executable application associated with the selected active feature.

61. The article of manufacture of claim 61 wherein the machine-readable medium having stored thereon instructions:
further comprises instructions to:
display indicia of each of the plurality of locations that has at least one associated active feature; and
accept user input including a selection of indicia for one of the plurality of locations that has at least one associated active feature; and
wherein the instruction to display of the plurality of active features comprises an instruction to display each active feature associated with the selected one of the locations.

62. An apparatus for providing a home-style user interface to a user of an interactive television system, the apparatus comprising:
means for displaying at least one active feature associated with one of a plurality of the user's surrounding locations;
communicatively coupled to the display means, means for selecting one of the at least one active feature; and
communicatively coupled to the selection means, means for invoking an executable application associated with the selected active feature.

63. A method of customizing a home-style user interface provided for a user of an interactive television system, the method comprising:
storing a status indicator for each of at least one feature associated with one of a plurality of the user's surrounding locations, the status indicator including information about whether the feature is active or inactive;
displaying setup indicia associated with the feature, the setup indicia including the status indicator information about whether the feature is active or inactive;
selecting the setup indicia associated with the feature; and
updating the status indicator for the feature from active to inactive, or from inactive to active.

64. An article of manufacture, comprising:
a machine-readable medium having stored thereon instructions to:
store a status indicator for each of at least one feature associated with one of a plurality of an interactive television system user's surrounding locations, the status indicator including information about whether the feature is active or inactive;
display setup indicia associated with the feature, the setup indicia including the status indicator information about whether the feature is active or inactive;
accept user input including a selection of the setup indicia associated with the feature; and
update the status indicator for the feature from active to inactive, or from inactive to active.

65. An apparatus for providing a home-style user interface to a user of an interactive television system, the apparatus comprising:
means for storing a status indicator for each of at least one feature associated with one of a plurality of the user's surrounding locations, the status indicator including information about whether the feature is active or inactive;
communicatively coupled to the storage means, means for displaying setup indicia associated with the feature, the setup indicia including the status indicator information about whether the feature is active or inactive;
communicatively coupled to the display means, means for selecting the setup indicia associated with the feature; and
communicatively coupled to the selection means, means for updating the status indicator for the feature from active to inactive, or from inactive to active.
